(19) United States
(12) Patent Application Publication
(10) Pub. No.: US 2026/0255208 A1
(43) Pub. Date: Aug. 27, 2026

(54) Communication Method and Related Products

(71) Applicant: HUAWEI TECHNOLOGIES CO., LTD., Shenzhen (CN)

(72) Inventors: Rojan Chitrakar, Singapore (SG); Bin Qian, Shenzhen (CN); Lei Huang, Singapore (SG); Xun Yang, Singapore (SG)

(73) Assignee: HUAWEI TECHNOLOGIES CO., LTD., Shenzhen (CN)

(21) Appl. No.: 19/656,527

(22) Filed: Apr. 23, 2026

Related U.S. Application Data
(63) Continuation of application No. PCT/CN2023/126304, filed on Oct. 24, 2023.

(51) Int. Cl. H04W 24/10; H04L 1/1607

(52) U.S. Cl. CPC H04W 24/10; H04L 1/1614

(57) ABSTRACT

A communication method includes a responder obtaining multiple measurement report frames based on a measurement report, wherein the measurement report is used to provide a result of measurement performed by the responder, the result of the measurement is carried in the multiple measurement report frames, and a respective measurement report frame of the multiple measurement report frames has a length not greater than a preset threshold.

### CROSS-REFERENCE TO RELATED APPLICATIONS

This is a continuation of International Patent Application No. PCT/CN2023/126304 filed on Oct. 24, 2023, which is hereby incorporated by reference in its entirety.

### TECHNICAL FIELD

The present disclosure relates to the field of communication technologies, and in particular, to a communication method and related products.

### BACKGROUND

Ultra-wideband (UWB) technology is increasingly being used for indoor positioning and other location services such as access control and asset locating. Aside from dedicated devices and tags, UWB radios are becoming increasingly common in high end smartphones.

Aside from the ranging use case, other use cases such as device free sensing, downlink time difference of arrival (DL-TDOA), long range ranging etc. are being actively investigated. An UWB device that supports sensing is called a sensing-capable device (SDEV). Sensing involves the use of UWB transmissions to obtain measurements to estimate features such as range, velocity, and motion of objects in an area of interest. Sensing measurements can enable various applications such as presence detection and environmental mapping.

This background information is provided to reveal information believed by the applicant to be of possible relevance to the present disclosure. No admission is necessarily intended, nor should be construed, that any of the preceding information constitutes prior art against the present disclosure.

### SUMMARY

In a first aspect, an embodiment of the present disclosure provides a communication method, the method being applied for ultra-wideband sensing and including obtaining, by a responder, multiple measurement report frames based on a measurement report, where the measurement report is used to provide a result of measurement performed by the responder, the result of the measurement is distributedly carried in the multiple measurement report frames, and a respective measurement report frame of the multiple measurement report frames has a length not greater than a preset threshold.

Since the result of the measurement is distributedly carried in the multiple measurement report frames, and a respective measurement report frame of the multiple measurement report frames has a length not greater than a preset threshold, such distribution of the measurement report in multiple measurement report frames serves to fit the length requirement of the measurement report frame, thereby enabling the responder to report the result of the measurement.

In a possible implementation of the first aspect, the method further includes receiving, by the responder, at least one sensing packet from an initiator; and measuring, by the responder, the at least one sensing packet to obtain the measurement report.

In a possible implementation of the first aspect, the method further includes transmitting, by the responder, the multiple measurement report frames to an initiator.

In a possible implementation of the first aspect, obtaining, by the responder, the multiple measurement report frames based on the measurement report includes obtaining, by the responder, multiple partial reports of the measurement report based on the measurement report; for a first partial report among the multiple partial reports, performing, by the responder, fragmentation on the first partial report to obtain a first number of fragments; and obtaining, by the responder, the multiple measurement report frames based on the first number of fragments for the first partial report.

By performing fragmentation on the partial report level, the boundaries of the partial report are taken into account, more flexibility would be given to the design of formats of report IEs for enabling such process.

In a possible implementation of the first aspect, the measurement report includes multiple partial reports, and a first partial report among the multiple partial reports is fragmented into a first number of fragments, each of the first number of fragments corresponds to a first fragment field for indicating whether the fragment carried in the respective measurement report frame is a first fragment of the report from which the fragment is obtained, a remaining fragment field for indicating the number of remaining fragments in the report from which the fragment is obtained, and a fragmented report length field for indicating the length related to the fragment.

In a possible implementation of the first aspect, fragments from different partial reports are carried in one measurement report frame.

In a possible implementation of the first aspect, the method further includes performing, by the responder, compression on a second partial report among the multiple partial reports.

By performing compression on some or all of the partial reports, the overall signaling overhead is reduced.

In a possible implementation of the first aspect, where a first measurement report frame corresponding to the first partial report is indicative of a first parameter specific to the first partial report, and the first measurement report frame carries a first fragment of the first partial report, and indications for the first parameter are omitted in remaining measurement report frames corresponding to the first partial report other than the first measurement report frame.

In a possible implementation of the first aspect, where the first measurement report frame includes a first parameter field for indicating the first parameter.

Since the first parameter specific to this partial report is common for all the fragments obtained, it is possible to simply carry the first parameter in the first measurement report frame corresponding to the first partial report, and omit indications for the first parameter in other measurement report frames corresponding to the first partial report, so as to reduce the signaling overhead.

In a possible implementation of the first aspect, where obtaining, by the responder, the multiple measurement report frames based on the measurement report includes performing, by the responder, fragmentation on the measurement report to obtain a second number of fragments; and obtaining, by the responder, the multiple measurement report frames based on the second number of fragments.

By performing fragmentation on the measurement report directly, the operation is simplified, and more flexibility would be given to the design of formats of report information elements (IEs) for enabling such process.

In a possible implementation of the first aspect, the measurement report is directly fragmented into a second number of fragments, each of the second number of fragments is carried in one measurement report frame, and the one measurement report frame includes a first fragment field for indicating whether the fragment carried in the respective measurement report frame is a first fragment of the report from which the fragment is obtained, a remaining fragment field for indicating the number of remaining fragments in the report from which the fragment is obtained, and a fragmented report length field for indicating the length related to the fragment.

In a possible implementation of the first aspect, the method further includes performing, by the responder, compression on the measurement report; where performing, by the responder, fragmentation on the measurement report includes performing, by the responder, fragmentation on the compressed measurement report.

In a possible implementation of the first aspect, a channel impulse response (CIR) bitmap field in the report parameters control field can also be compressed with the measurement report.

In a possible implementation of the first aspect, where a second measurement report frame of the multiple measurement report frames is indicative of a second parameter for all partial reports of the measurement report, and the second measurement report frame is a first measurement report frame among the multiple measurement report frames, and indications for the second parameter are omitted in remaining measurement report frames other than the second measurement report frame.

In a possible implementation of the first aspect, where the second measurement report frame includes a second parameter field for indicating the second parameter.

In a possible implementation of the first aspect, where the second measurement report frame further includes a parameter indication field for indicating whether the second parameter field is present.

The measurement report may include multiple partial reports, and the second parameter may be parameters common to all partial reports of the measurement report, that is, the multiple measurement report frames used for carrying all the partial reports share the second parameter, so it is possible to simply carry the second parameter in the first measurement report frame among the multiple measurement report frames, and omit indications for the second parameter in other measurement report frames, so as to reduce the signaling overhead.

In a possible implementation of the first aspect, where the respective measurement report frame is indicative of a number of taps carried in the respective measurement report frame, and the indicated number of taps are less than a total number of taps to be reported.

In a possible implementation of the first aspect, where the respective measurement report frame includes a tap bitmap field for indicating the number of taps carried in the respective measurement report frame, and a bitmap indicated by the tap bitmap field is smaller than a bitmap required to indicate the total number of taps to be reported.

In a possible implementation of the first aspect, where the respective measurement report frame is indicative of whether a fragment carried in the respective measurement report frame is a first fragment of a report from which the fragment is obtained, a number of remaining fragments in the report from which the fragment is obtained, and a length related to the fragment.

In a possible implementation of the first aspect, where the respective measurement report frame includes a first fragment field for indicating whether the fragment carried in the respective measurement report frame is a first fragment of the report from which the fragment is obtained, a remaining fragment field for indicating the number of remaining fragments in the report from which the fragment is obtained, and a fragmented report length field for indicating the length related to the fragment.

For the case where the fragmentation is done at the partial report level with consideration on the boundaries of the partial reports, since the CIR taps included in a partial report may be distributed into multiple fragments, and it is possible that a measurement report frame corresponds to more than one fragment, so each fragment included in the measurement report frame may be indicated with the first fragment field, the remaining fragment field and the fragmented report length field, so that the initiator could identify the fragment, and arrange multiple fragments of the same partial report in a correct order. For the case where the fragmentation is done directly on the measurement report without considering the boundaries, each measurement report frame may include the first fragment field, the remaining fragment field and the fragmented report length field to indicate the fragment carried therein.

In a possible implementation of the first aspect, where the respective measurement report frame further includes a fragment indication field for indicating whether the first fragment field, the remaining fragment field and the fragmented report length field are present.

The introduction of the presence field may enable quick determination of whether the fragment indication field, the remaining fragment field and the fragmented report length field are present, without decoding values carried in these actual fields.

In a possible implementation of the first aspect, where a respective measurement report frame of the multiple measurement report frames is indicative of an identification of the respective measurement report frame and the measurement.

In a possible implementation of the first aspect, where the respective measurement report frame includes a report number for indicating the identification of the measurement report frame and a measurement number for identifying the measurement.

Since the measurement report frame carries the report number and measurement number to identify the partial report, so that partial report corresponding a specific receive antenna and segment pair on a particular channel can be accurately identified.

In a possible implementation of the first aspect, where the respective measurement report frame is further indicative of a segment to which a fragment of the measurement report carried by the respective measurement report frame belongs, an antenna of the responder for receiving the segment and a channel on which the segment is received.

In a possible implementation of the first aspect, where the respective measurement report frame includes a segment field for identifying the segment to which the fragment of the measurement report carried by the respective measurement report frame belongs, an antenna field for identifying the antenna of the responder for receiving the segment and a channel field for identifying the channel on which the segment is received.

Since the first measurement report frame may be divided into two or more partial reports, each partial report carrying all the CIR taps corresponding to a receive antenna and segment pair on a particular channel; so that the partial report allows the measurement report to be divided into smaller components, each component carrying a complete set of CIR taps for a receive antenna and segment pair. Even if some components are not received, the remaining received components can still be parsed, allowing partial sensing measurements to be obtained.

In a second aspect, an embodiment of the present disclosure provides a communication method, the method being applied for ultra-wideband sensing and including receiving, by an initiator, multiple measurement report frames from a responder, where the multiple measurement report frames are obtained based on a measurement report, where the measurement report is used to provide a result of measurement performed by the responder, the result of the measurement is distributedly carried in the multiple measurement report frames, and a respective measurement report frame of the multiple measurement report frames has a length not greater than a preset threshold.

In a third aspect, an embodiment of the present disclosure provides a communication apparatus, the apparatus includes various modules configured to execute the communication method according to the first aspect or any possible implementation of the first aspect.

In a fourth aspect, an embodiment of the present disclosure provides a communication apparatus, the apparatus includes various modules configured to execute the communication method according to the second aspect or any possible implementation of the second aspect.

In a fifth aspect, an embodiment of the present disclosure provides a responder including processing circuitry for executing the communication method according to the first aspect or any possible implementation of the first aspect.

In a sixth aspect, an embodiment of the present disclosure provides an initiator including processing circuitry for executing the communication method according to the second aspect or any possible implementation of the second aspect.

In a seventh aspect, an embodiment of the present disclosure provides a communication system, including the responder according to the fifth aspect and the initiator according to the sixth aspect.

In an eighth aspect, an embodiment of the present disclosure provides a computer-readable medium storing computer execution instructions which, when executed by a processor, causes the processor to execute the communication method according to the first aspect or any possible implementation of the first aspect or according to the second aspect or any possible implementation of the second aspect.

In a ninth aspect, an embodiment of the present disclosure provides a computer program product including computer execution instructions which, when executed by a processor, causes the processor to execute the communication method according to the first aspect or any possible implementation of the first aspect or according to the second aspect or any possible implementation of the second aspect.

According to the communication method provided by the present application, the responder obtains multiple measurement report frames based on a measurement report which is used to provide a result of measurement performed by the responder, the result of the measurement is distributedly carried in the multiple measurement report frames, and a respective measurement report frame of the multiple measurement report frames has a length not greater than a preset threshold. Such distribution of the measurement report in multiple measurement report frames serves to fit the length requirement of the measurement report frame, thereby enabling the responder to report the result of the measurement.

### BRIEF DESCRIPTION OF DRAWINGS

Reference will now be made, by way of example, to the accompanying drawings which show example embodiments of the present disclosure.

FIG. 1 is a simplified schematic illustration of a communication system according to one or more embodiments of the present disclosure.

FIG. 2 is a schematic illustration of an example communication system according to one or more embodiments of the present disclosure.

FIG. 3 is a schematic illustration of a basic component structure of a communication system according to one or more embodiments of the present disclosure.

FIG. 4 illustrates a block diagram of a device in a communication system according to one or more embodiments of the present disclosure.

FIG. 5 is a flowchart of interaction between a responder and an initiator according to one or more embodiments of the present disclosure.

FIG. 6 is a schematic diagram of a Receive Reports field according to one or more embodiments of the present disclosure.

FIG. 7 is a schematic flowchart of a communication method according to one or more embodiments of the present disclosure.

FIG. 8 is a schematic flowchart of a communication method according to one or more embodiments of the present disclosure.

FIG. 9 is a schematic flowchart of a communication method according to one or more embodiments of the present disclosure.

FIG. 10 is a schematic flowchart of a communication method according to one or more embodiments of the present disclosure.

FIG. 11 is a schematic flowchart of a communication method according to one or more embodiments of the present disclosure.

FIG. 12 is a format of a sensing measurement report frame carrying a CIR report IE according to one or more embodiments of the present disclosure.

FIG. 13 is an exemplary format of a CIR report IE according to one or more embodiments of the present disclosure.

FIG. 14 is an example of fragmentation of receive reports according to one or more embodiments of the present disclosure.

FIG. 15A to FIG. 15C are examples of fragmentation of receive reports according to one or more embodiments of the present disclosure.

FIG. 16 is an example of fragmentation of receive reports according to one or more embodiments of the present disclosure.

FIG. 17A and FIG. 17B are examples of fragmentation of receive reports according to one or more embodiments of the present disclosure.

FIG. 18 is an example of fragmentation of receive reports according to one or more embodiments of the present disclosure.

FIG. 19 is an example of fragmentation of receive reports according to one or more embodiments of the present disclosure.

FIG. 20 is an exemplary format of a CIR report IE according to one or more embodiments of the present disclosure.

FIG. 21 is an example of transmission of sensing packets according to one or more embodiments of the present disclosure.

FIG. 22A and FIG. 22B are examples of measurement reports according to one or more embodiments of the present disclosure.

FIG. 23A and FIG. 23B are examples of measurement reports according to one or more embodiments of the present disclosure.

FIG. 24 is an example of transmission of sensing packets according to one or more embodiments of the present disclosure.

FIG. 25 is an example of an aggregated measurement report according to one or more embodiments of the present disclosure.

FIG. 26 is an exemplary format of a processed target feature IE according to one or more embodiments of the present disclosure.

FIG. 27 is an exemplary format of a CIR report IE according to one or more embodiments of the present disclosure.

FIG. 28 is an example of fragmentation of receive reports according to one or more embodiments of the present disclosure.

FIG. 29 shows a schematic structural diagram of a communication apparatus according to one or more embodiments of the present disclosure.

FIG. 30 shows a schematic structural diagram of a communication apparatus according to one or more embodiments of the present disclosure.

### DESCRIPTION OF EMBODIMENTS

To describe the technical solutions in embodiments of the present disclosure more clearly, the following briefly introduces the accompanying drawings needed for describing the embodiments.

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below.

### Example Communication Systems and Devices

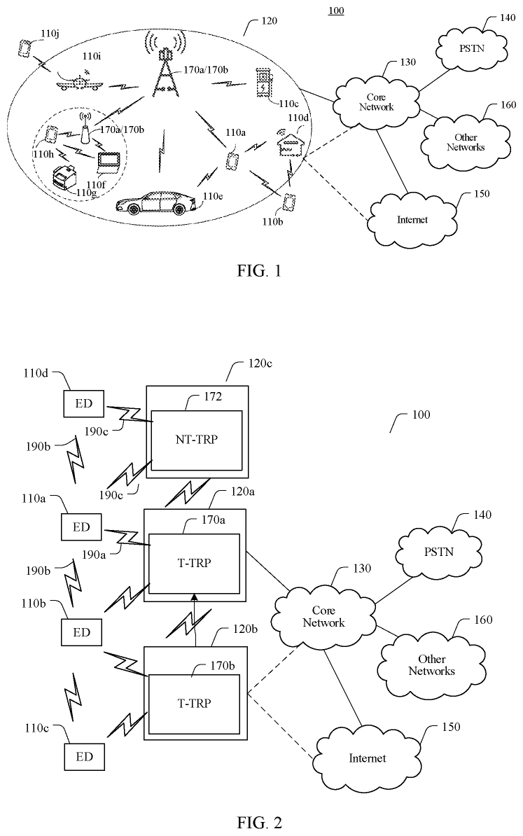

Referring to FIG. 1, as an illustrative example without limitation, a simplified schematic illustration of a communication system is provided. The communication system 100 includes a radio access network 120. The radio access network 120 may be a next generation (e.g., sixth generation (6G) or later) radio access network, or a legacy (e.g., fifth generation (5G), fourth generation (4G), third generation (3G), or second generation (2G)) radio access network, or a wireless local area network (WLAN) (e.g., based on 802.11). One or more communication electric device (ED) 110a-110j (generically referred to as 110) may be interconnected to one another or connected to one or more network nodes (170a, 170b, generically referred to as 170) in the radio access network 120. One or more EDs 110a-110j also comprise UWB modules and are capable of performing sensing of the surrounding environment using UWB signals. A core network 130 may be a part of the communication system and may be dependent or independent of the radio access technology used in the communication system 100. Also, the communication system 100 includes a public switched telephone network (PSTN) 140, the Internet 150, and other networks 160.

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network including multiple layers. Compared to other communication networks, the heterogeneous network may achieve better overall performance through efficient multi-link joint operation, more flexible functionality sharing, and faster physical layer link switching between terrestrial networks and non-terrestrial networks. In the simplest form the communication system 100 may even be just a single ED that can perform mono-static sensing of the surrounding environment, or a pair of EDs that can engage in bi-static sensing of the surrounding environment, or three or more EDs that can engage in multi-static sensing of the surrounding environment.

The terrestrial communication system and the non-terrestrial communication system could be considered sub-systems of the communication system. In the example shown, the communication system 100 includes ED 110a-110d, radio access networks (RANs) 120a-120b, non-terrestrial communication network 120c, a core network 130, a PSTN 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the Internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code-division multiple access (CDMA), time-division multiple access (TDMA), frequency-division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. In some examples, the link is a dedicated connection for unicast transmission, a connection for broadcast transmission, or a connection between a group of EDs and one or multiple NT-TRPs for multicast transmission.

The air interfaces 190a, 190b and 190c may also use UWB technology to perform sensing of the surrounding environment using UWB signals.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

### Basic Component Structure

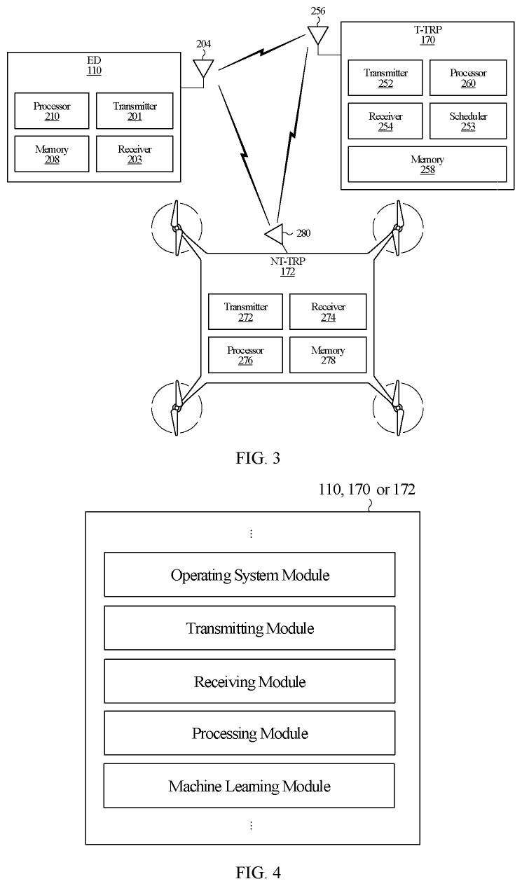

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle-to-everything (V2X), peer-to-peer (P2P), machine-to-machine (M2M), machine-type communications (MTC), Internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices as a user equipment/device (UE), a wireless transmit/receive unit (WTRU), a mobile station, a fixed or mobile subscriber unit, a cellular telephone, a station (STA), an MTC device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random-access memory (RAM), read-only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next generation NodeB (gNB), a transmission point (TP)), a site controller, an access point (AP), or a wireless router, a relay station, a remote radio head, a terrestrial node, a terrestrial network device, or a terrestrial base station, baseband unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as an FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

### Basic Module Structure

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### Air Interface

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g., a “sidelink”), and/or the wireless communications link may support a link between a non-terrestrial (NT)-communication network and UE. The air interfaces may also use UWB technology to perform sensing of the surrounding environment using UWB signals.

The following are some examples for the above components.

A waveform component may specify a shape and form of a signal being transmitted. Waveform options may include orthogonal multiple access waveforms and non-orthogonal multiple access waveforms. Non-limiting examples of such waveform options include orthogonal frequency-division multiplexing (OFDM), filtered OFDM (f-OFDM), time windowing OFDM, filter bank multicarrier (FBMC), universal filtered multicarrier (UFMC), generalized frequency-division multiplexing (GFDM), wavelet packet modulation (WPM), faster than Nyquist (FTN) waveform, high rate pulse repetition frequency (HRP) UWB waveform, low rate pulse repetition frequency (LRP) UWB waveform and low peak-to-average power ratio waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as TDMA, FDMA, CDMA, SC-FDMA, low density signature multicarrier CDMA (LDS-MC-CDMA), non-orthogonal multiple access (NOMA), pattern division multiple access (PDMA), lattice partition multiple access (LPMA), resource spread multiple access (RSMA), and sparse code multiple access (SCMA). Furthermore, multiple access technique options may include scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support below 6 gigahertz (GHz) and beyond 6 GHz frequencies (e.g., millimeter-wave (mmWave)) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible RAN slicing through channel resource sharing between different services in both frequency and time.

### Terminal Types

The data processing method provided in the embodiment of the present disclosure may be applied to various communication scenarios, for example, may be applied to one or more of the following communication scenarios: enhanced mobile broadband (eMBB), ultra-reliable low-latency communication (URLLC), and MTC, IoT, narrowband IoT (NB-IoT), customer premises equipment (CPE), AR, VR, mass MTC (mMTC), D2D, V2X, V2V, etc.

It should be noted that in the embodiment of the present disclosure, IoT may include one or more of NB-IoT, MTC, mMTC, and the like. This is not limited.

The eMBB may be a large-traffic mobile broadband service such as a three-dimensional (3D) or ultra-high-definition video. Further, the eMBB may further improve performance such as a network speed and user experience based on a mobile broadband service. For example, when a user watches a 4K high definition (HD) video, the peak network speed can reach 10 Gbit/s.

URLLC may refer to a service with high reliability, low latency, and extremely high availability. Further, the URLLC may include the following communications scenarios and applications: industrial application and control, traffic safety and control, remote manufacturing, remote training, remote surgery, unmanned driving, industrial automation, a security industry, and the like.

MTC may refer to a low-cost and coverage-enhanced service, and may also be referred to as M2M. mMTC refers to large-scale IoT services.

NB-IoT may be a service that features wide coverage, a large number of connections, a low rate, a low cost, low power consumption, and an excellent architecture. Further, the NB-IoT may include a smart water meter, smart parking, intelligent pet tracking, a smart bicycle, an intelligent smoke detector, an intelligent toilet, an intelligent vending machine, and the like.

The CPE may refer to a mobile signal access device that receives a mobile signal and forwards the mobile signal by using a WiFi signal, or may refer to a device that converts a high-speed 4G or 5G signal into a WiFi signal, and may simultaneously support a relatively large quantity of mobile terminals that access the Internet. CPEs can be widely used for wireless network access in rural areas, towns, hospitals, units, factories, and residential areas, reducing the cost of laying wired networks.

The V2X can enable communication between vehicles, between vehicles and network devices, and between network devices, to obtain a series of traffic information such as a real-time road condition, road information, and pedestrian information, and provide in-vehicle entertainment information to improve driving safety, reduce congestion, and improve traffic efficiency.

For example, the terminal type includes an eMBB device, a URLLC device, an NB-IoT device, and a CPE device. The eMBB device is mainly configured to transmit large-packet data, or may be configured to transmit small-packet data, and is generally in a moving state. Requirements for a transmission delay and reliability are general, and both uplink and downlink communication exists. A channel environment is relatively complex and changeable, and indoor communication or outdoor communication may be used. For example, an eMBB device may be a mobile phone. The URLLC device is mainly configured to transmit small packet data, or may transmit medium packet data. Generally, the URLLC device belongs to a non-moving state, or may move along a fixed route. The URLLC device has a relatively high requirement for a transmission delay and reliability, that is, a low transmission delay and high reliability are required, and both uplink and downlink communications have. The channel environment is stable. For example, the URLLC device may be a factory device. The NB-IoT device is mainly used to transmit small data. The NB-IoT device is generally in a non-moving state, has a known location, has a medium transmission delay and reliability requirement, has a relatively large amount of uplink communication, and has a relatively stable channel environment. For example, the NB-IoT device may be a smart water meter or a sensor. The CPE device is mainly used to transmit large-packet data, is generally in a non-mobile state, or can move over ultra-short distances, has medium requirements on transmission delay and reliability, has both uplink and downlink communication, and has a relatively stable channel environment. For example, The CPE device may be a terminal device, an AR, a VR, or the like in the smart home. When the terminal type of the terminal device is determined, the terminal type may be determined based on a service type, mobility, a transmission delay requirement, a reliability requirement, a channel environment, and a communication scenario of the terminal device. Determining that the terminal type corresponding to the terminal device is an eMBB device, a URLLC device, an NB-IoT device, or a CPE device.

As descried in the related art, UWB technology is increasingly being used for indoor positioning and other location services such as access control and asset locating. Aside from dedicated devices and tags, UWB radios are becoming increasingly common in high end smartphones.

Aside from the ranging use case, other use cases such as device free sensing, DL-TDOA, long range ranging etc. are being actively investigated. An UWB device that supports sensing is called a SDEV. Sensing involves the use of UWB transmissions to obtain measurements to estimate features such as range, velocity, and motion of objects in an area of interest. Sensing measurements can enable various applications such as presence detection and environmental mapping.

Based on its role during the sensing measurements, an SDEV may assume any one or more of the following roles:
sensing initiator: an SDEV that initiates a sensing session with other SDEVs, which could also be referred to as an initiator, where the sensing session may be from a time point where the initiator sends a session setup request message to a time point where the initiator receives reports of all measurement instances from a responder, the sensing session may include one or more sensing measurement instances, one measurement instance represents the measurement(s) performed for one purpose, for example, in order to measure the channel condition of one or more channels, the initiator would send one or more channel sounding PHY protocol data units (PPDU) to the responder, and the responder may measure the one or more PPDUs (e.g., measure one or more segments of each PPDU) and reports the result of the measurement(s), such measurement(s) would be regarded as one measurement instance;
controller: an SDEV that controls the sensing session and defines the sensing parameters.
controlee: an SDEV that utilizes the sensing parameters received from the controller.
sensing responder: an SDEV that participates in a sensing session initiated by an initiator, which is also referred to as a responder;
sensing transmitter: an SDEV that transmits a channel sounding PHY PPDU to be used for performing the sensing measurements, which is also referred to as a transmitter, and the channel sounding PPDU can also be referred to as a sensing PPDU or a sensing packet, including one or more segments;
sensing receiver: an SDEV that receives the channel sounding PPDU and performs the sensing measurements, which is also referred to as a receiver;
sensing requesting device: an SDEV that requests another SDEV to perform the sensing measurements in a proxy application.

The initiator may be the transmitter or the receiver, when the initiator is the transmitter, the responder is the receiver, and vice versa. In the following description, an example where the initiator is the transmitter and the responder is the receiver would be taken to illustrate the technical solution of the present application, but it should be understood that the solution of the present application is also applicable for the case where the initiator is the receiver, and the responder is the transmitter.

In most sensing scenarios, the sensing application runs on the initiator. When the initiator is the sensing transmitter and transmits the sensing packet (e.g., PPDU) to the responder, the responder (sensing receiver) may send an over-the-air (OTA) sensing measurement report including one or more (sensing) measurement report frames carrying the results of the sensing measurements to the initiator. Two types of sensing measurement reports are supported as follows.

### 1) Windows-Based CIR Report

The sensing measurement report carries the CIR taps measured within a certain time window.

### 2) Processed Target Features Report

The sensing measurement report carries the process report for sensing such as angle of arrival (AoA), range, velocity, radar cross section (RCS) etc. For sensing applications, using wider channel bandwidth is beneficial to improve the sensing link budget and accuracy of sensing measurements. A channel aggregation scheme, known as frequency stitching, allows multiple carrier frequencies to be combined, allowing sensing measurements to be performed over a much wider channel bandwidth compared to an SDEV's default operating channel bandwidth. Frequency stitching may be performed with overlapping channel frequencies or non-overlapping channel frequencies, the carrier frequency grid configuration parameter determining the percentage of overlap. Carrier frequency grids of 0, 1, 2, and 3 represent no overlap, 25% overlap, 50% overlap and 75% overlap respectively. As for the frequency stitching type, which refers to the method used for the transmission of the channel sounding PPDU (sensing PPDU), it may be one of: intra-packet frequency stitching: different segments of the same sensing PPDU are transmitted on different channels, the segment may also be referred to as a sensing segment; inter-packet frequency stitching: multiple sensing PPDUs are transmitted on different channels, and different segments of the same sensing PPDU are transmitted on the same channel; combined intra-packet frequency stitching and inter-packet frequency stitching: combination of the above two transmission methods.

Some other terminologies related to frequency stitching are: base channel, refers to a starting channel for performing UWB sensing when frequency stitching is enabled, and the starting channel refers to a channel on which fields such as a synchronization (SYNC) field and a start of frame delimiter (SFD) field are first transmitted; the number of transmissions, which is the total number of transmissions to be done at the different channel center frequencies for one measurement instance. In other words, number of transmissions refers to the number of carrier frequencies used for the frequency stitching.

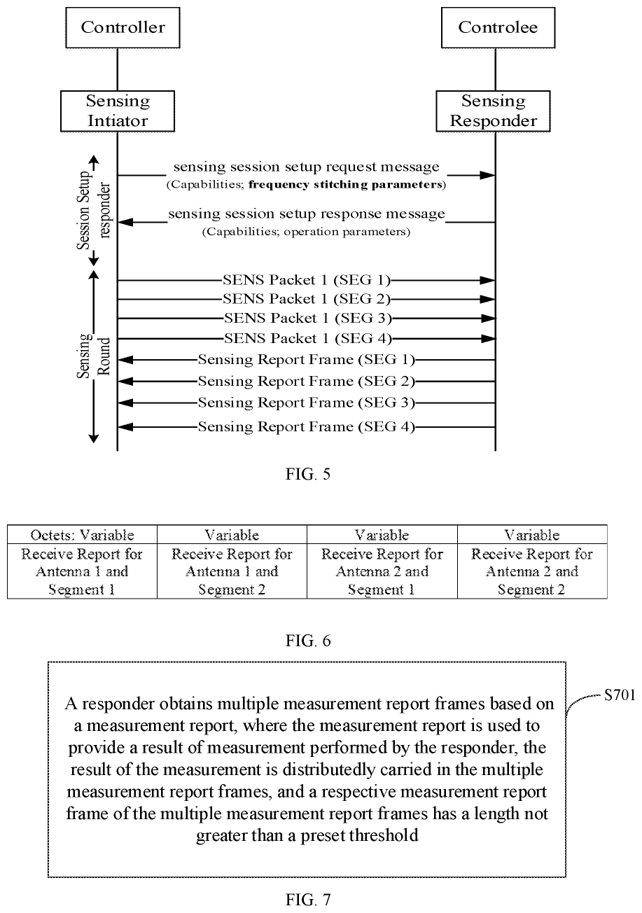

In the following, the process of one sensing measurement instance between the initiator and the responder will be described with reference to FIG. 5. As shown in FIG. 5, during the session setup phase, an SDEV can be regarded as a controller and assumes itself as an initiator, and determines another SDEV (controlee shown in FIG. 5) as a responder, that is, the controller assumes the role of the initiator and assigns the role of the responder to the controlee. The initiator first sends a sensing session setup request message to the responder to initiate a sensing session with the responder, where the sensing session setup request message includes the initiator's sensing capabilities, an AC IE carrying parameters related to sensing as well as frequency stitching. The responder responds with a sensing session setup response message carrying its sensing capabilities as well as operating parameters. This session setup phase is actually a handshake between the controller and the controlee, so that both parties could know capabilities of the other party so as to implement subsequent sensing. Subsequently in a sensing round (one time of sensing packet transmission and measuring), the initiator transmits a sensing packet with four segments, each segment transmitted on one of the four different carrier frequencies as specified by the frequency stitching carrier frequency grid parameter (which may be notified as one of frequency stitching parameters by the initiator). Upon receiving the sensing packet, the responder measures the CIR taps for each of the bit set to 1 in the CIR Bitmap field of the AC IE. A partial CIR report is generated for each of the pair made up of the responder's receive antenna and segment of the sensing packet for each of the frequency stitched channel. In this example, the feedback control field of the AC IE would be set to a value of 1 indicating report for all transmissions after the last transmission, and four sensing measurement report frames are transmitted, each frame carrying the partial CIR reports corresponding to one segment. The responder then transmits four measurement report frames respectively corresponding to the fourth sensing packets according to the fourth sensing packets. Here it should be noted that the number of segments shown in the figure is simply exemplary, and there could be more or less segments in actual applications.

As described in the above part, there are generally two kinds of reports adopted by the responder to realize the sensing report frame as shown in FIG. 5. In the following, the CIR report may be taken as an example to describe related frame structures. It is proposed that the CIR taps corresponding to a sensing measurement are carried in a CIR report IE, and the CIR report IE carried in the measurement report frame. The CIR taps are measured for each receive antenna of the responder and segment transmitted by the initiator pair and placed in receive report(s) field of the CIR report IE in a fixed order, e.g., in the sequence of antenna ID first and the segment index second. For example, when there are two receive (Rx) antennas and two segments, the measurement report frame is formatted as shown in FIG. 6.

The above CIR report format may work well when all the CIR taps corresponding to a single sensing measurement are carried in the same CIR report IE, but it is possible that the CIR taps are split across multiple CIR report IEs and multiple frames, so the initiator may have difficulty assembling the CIR taps in the correct order. A typical frame may only be able to carry a payload of less than 1000 octets, so when the size of the CIR report exceeds the capacity of the frame, it is necessary for adopting a CIR report format which can support the splitting of the CIR report across multiple CIR report IEs and multiple frames.

Solutions are proposed to introduce a fragmentation scheme for the sensing measurement reports to allow: distributing the partial reports corresponding to the same sensing measurement instance across multiple CIR report IEs and/or frame; fragmented reports when the frame carrying the sensing measurement report is not large enough to carry an entire sensing measurement report (CIR taps). Here a partial report (or a CIR partial report) in the embodiments of the present disclosure refers to a report carrying all the CIR taps corresponding to a receive antenna and segment pair or corresponding to a receive antenna and segment pair on a particular channel. The partial report is generally carried in the receive report(s) field of a CIR report IE.

In a possible implementation of the present disclosure, a partial report corresponds to a first reporting set of a segment of the at least one sensing packet (for channel measurement purpose as mentioned with reference to step S701) transmitted from the initiator to the responder and an antenna of the responder for receiving the segment. Here the first reporting set could also be referred to as a combination or a pair or a group of a segment of the at least one sensing packet and an antenna of the responder for receiving the segment. That is, each partial report carries all the CIR taps corresponding to a receive antenna and segment pair. For example, when the at least one sensing packet includes one sensing packet, and this sensing packet includes two segments (SEG1 and SEG2), and the responder has two receive antennas (ANT1 and ANT2), then there would be four partial reports (PR1, PR2, PR3 and PR4), each partial report corresponds to a segment and antenna pair, where PR1 corresponds to the set of SEG1 and ANT1, PR2 corresponds to the set of SEG2 and ANT1, PR3 corresponds to the set of SEG1 and ANT2, PR4 corresponds to the set of SEG2 and ANT2.

In a possible implementation of the present disclosure, the partial report corresponds to a second reporting set of a segment of the at least one sensing packet, an antenna of the responder for receiving the segment and a first channel on which the segment is transmitted by the initiator. Here the second reporting set could also be referred to as a combination or a pair or a group of a segment of the at least one sensing packet, an antenna (or the corresponding receive (RX) chain) of the responder for receiving the segment and a first channel on which the segment is transmitted by the initiator. That is, each partial report carries all the CIR taps corresponding to a receive antenna and segment pair on a particular channel. For example, when the at least one sensing packet includes one sensing packet, this sensing packet includes two segments (SEG1 and SEG2) and is transmitted on one channel (CH1), and the responder has two receive antennas (ANT1 and ANT2), then there would be four partial reports (PR1′, PR2′, PR3′ and PR4′), each partial report corresponds to a segment and antenna pair, where PR1′ corresponds to the set of SEG1, ANT1 and CH1, PR2 corresponds to the set of SEG2, ANT1 and CH1, PR3 corresponds to the set of SEG1, ANT2 and CH1, PR4 corresponds to the set of SEG2, ANT2 and CH1.

At the first level, it is possible to perform fragmentation on receive reports at the partial report level, that is, all the CIR report (CIR taps) corresponding to a single sensing measurement (a measurement instance) may be divided into two or more partial CIR reports, each partial CIR report carrying all the CIR taps corresponding to a receive antenna and segment pair (on a particular channel).

At the second level, it is also possible to further perform fragmentation on the partial report, that is, the partial CIR report may be further divided into two or more CIR report fragments, each fragment carrying a limited number of CIR taps corresponding to a receive antenna and segment pair (on a particular channel).

The fragmentation may also be performed in other ways, for example, directly on the measurement report, without dividing the measurement report into partial reports at first.

In order to realize the reduction of the size of the receive reports which carry all the CIR report (CIR taps) corresponding to a single sensing measurement (a measurement instance), it is also possible to compress the partial CIR report prior to fragmentation, each fragment carrying a portion of the compressed CIR report.

The solution proposed by the present disclosure can be applied in any UWB sensing application that uses (sensing) measurement report frames. Besides, the solution of the present disclosure may be implemented in tags, smartphones, laptops, key fobs, vehicle, door locks etc. That is, the initiator and the responder can be devices such as tags, smartphones, laptops, key fobs, vehicle, door locks etc.

The embodiments of the present disclosure will be elaborated with reference to accompanying figures. The present disclosure provides a communication method, which is applied for ultra-wideband sensing. Reference may be made to FIG. 7, the communication method may include the following steps.

S701, a responder obtains multiple measurement report frames based on a measurement report, where the measurement report is used to provide a result of measurement performed by the responder, the result of the measurement is distributedly carried in the multiple measurement report frames, and a respective measurement report frame of the multiple measurement report frames has a length not greater than a preset threshold.

The measurement here refers to a measurement instance mentioned above, and the result of the measurement refers to all the measurement results obtained in the measurement, e.g., all the receive reports of one measurement instance.

The responder may perform measurement to complete a sensing task, for example, measuring conditions of some channels. In a possible implementation, the measurement may be done by measuring the sensing packet(s) received from the initiator, in this case, upon receiving the one or more sensing packets (at least one sensing packet) from the initiator, the responder may obtain multiple measurement report frames based on the one or more sensing packets. For example, the responder may measure the CIR taps for each segment of the sensing packet(s) using its receive antenna(s) to obtain a measurement report which carry all measurement results of one measurement instance, e.g., results obtained by measuring all of the one or more sensing packets received from the initiator for completing the same sensing task, or all the receive reports as carried in the above receive report(s) field. In this case, the measurement may include the transmission and measurement of one or more sensing packets. Detailed description will be made later with reference to specific examples. Each of the at least one sensing packet may include one or more segments. Relevant techniques in existing art would be adopted for the segmentation of the sensing packet, the number of segments of a sensing packet and the manner in which the sensing packet is segmented are not limited in the embodiments of the present disclosure. For example, a segment may be a SENS field of an HRP-SDEV PPDU.

It should be noted that the sensing packet mentioned above may be any packet that could be interchanged between an initiator and a responder for achieving the measurement of conditions of channels, in a possible implementation of the present disclosure, the sensing packet could be a sensing PPDU (e.g., an HRP-SDEV PPDU) which is transmitted from the initiator to the responder through one or more channels. It should be noted that the number of sensing packets may be one or multiple, which is not limited in the embodiments of the present disclosure. The number of sensing packets can be determined based on actual needs, for example, when it is required to measure multiple channels, then it is possible to achieve such requirement with one sensing packet including multiple segments or with multiple sensing packets (each first sensing packet may include one or more segments).

After performing the measurement, the responder may obtain the measurement report, in order to provide this measurement report to the initiator, the responder may use multiple measurement report frames. That is, the obtained measurement report may be fragmented so as to make sure that each measurement report frame carrying a fragment or multiple fragments meets a length requirement, i.e., each measurement report frame has a length not greater than a preset threshold. The number of the multiple measurement report frames may be determined based on the sensing task, if the obtained measurement report has a very large size, then more measurement report frames may be needed. Here the fragmentation may be done in several ways, at the partial report level or further in a smaller granularity. For example, as mentioned above, the result of the measurement may include multiple partial reports, so the fragmentation may be done at the partial report level, that is, all the receive reports can be divided in terms of partial reports. For another example, it is also possible to further perform fragmentation on the partial report. Details will be elaborated with reference to specific examples later.

In a possible implementation, the preset threshold may be 1000 octets, which represents the payload limit for a measurement report frame. In another implementation, the preset threshold may not be a fixed number, but may be decided based on the number of payload octets that can be carried in the report frame (after considering the overhead of a medium access control (MAC) header, IE header, a frame check sequence (FCS) field etc.).

In a possible implementation of the present disclosure, after the responder obtains the multiple measurement report frames, the method further includes that the responder transmitting the multiple measurement report frames to an initiator.

According to the communication method provided by the present application, the responder obtains multiple measurement report frames based on a measurement report which is used to provide a result of measurement performed by the responder, the result of the measurement is distributedly carried in the multiple measurement report frames, and a respective measurement report frame of the multiple measurement report frames has a length not greater than a preset threshold. Such distribution of the measurement report in multiple measurement report frames serves to fit the length requirement of the measurement report frame, thereby enabling the responder to report the result of the measurement.

There may be two different ways to perform the fragmentation, one is to obtain partial reports of the measurement report and then perform fragmentation on the partial reports with consideration of the boundaries of partial reports, the other is to directly perform fragmentation on the measurement report without consideration of the boundaries of partial reports. When performing the fragmentation on the partial report, there would also be different formats of CIR report IEs. Details will be described in the following with reference to relevant figures.

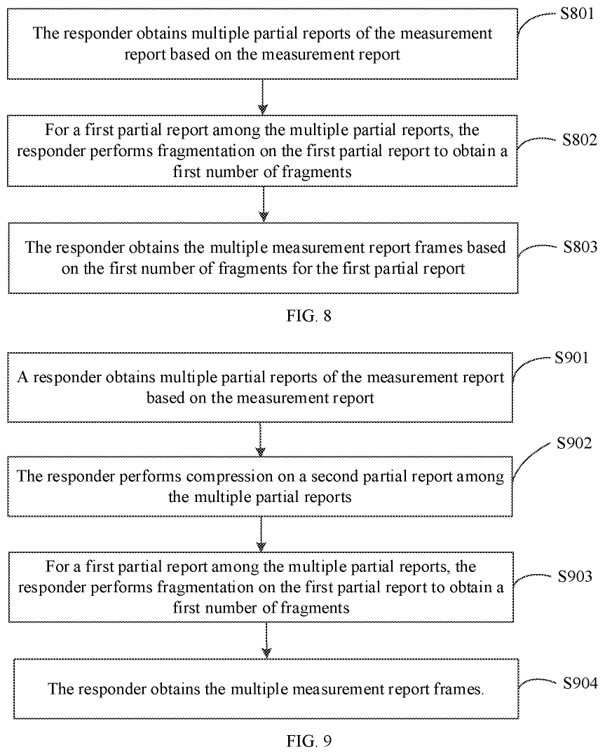

One way is to perform the fragmentation on the partial reports of the measurement report. On the basis of the communication method shown in FIG. 7, FIG. 8 is a schematic flowchart of a communication method according to another embodiment of the present disclosure. As shown in FIG. 8, the method includes as follows.

S801, the responder obtaining multiple partial reports of the measurement report based on the measurement report.

S802, for a first partial report among the multiple partial reports, the responder performing fragmentation on the first partial report to obtain a first number of fragments.

S803, the responder obtaining the multiple measurement report frames based on the first number of fragments for the first partial report.

As mentioned above, the multiple measurement report frames may be obtained through performing fragmentation on the partial report level as shown in FIG. 8, here the first partial report may be one or more, which is not limited in the embodiments of the present application. That is, some or all of the partial reports included in the measurement report (carried in the Receive Report(s) field shown in the following examples) can be fragmented by taking the boundaries of partial reports into account.

It should be noted although examples in the present disclosure are given by performing fragmentation on all the partial reports, however, the solution is also applicable for cases where the fragmentation is performed on one or some of the partial reports.

Besides, the specific value of the first number here may be determined based on actual needs, which is not limited in the embodiments of the present application. When there are multiple partial reports subject to fragmentation, that is, the multiple partial reports are all “first partial report” mentioned above, then the first number for each of the multiple partial reports can be the same, or can be different, which is not limited in the embodiments of the present application.

In a possible implementation of the first aspect, the measurement report includes multiple partial reports, and a first partial report among the multiple partial reports is fragmented into a first number of fragments, each of the first number of fragments corresponds to a first fragment field for indicating whether the fragment carried in the respective measurement report frame is a first fragment of the report from which the fragment is obtained, a remaining fragment field for indicating the number of remaining fragments in the report from which the fragment is obtained, and a fragmented report length field for indicating the length related to the fragment. Here the first fragment field may be implemented as the first report fragment field in the following examples, the remaining fragment field may be implanted as the remaining report fragments field in the following examples, and the fragmented report length field may be implemented as the partial report length field in the following examples.

In a possible implementation of the present disclosure, fragments from different partial reports are carried in one measurement report frame. For the partial reports subject to fragmentation, each partial report may be divided into multiple fragments, and it is possible to combinedly carry fragments from different partial reports into one measurement report frame, so as to reduce the number of measurement report frames and thus reduce the overall signaling overhead.

By performing fragmentation on the partial report level, the boundaries of the partial report are taken into account, more flexibility would be given to the design of formats of report IEs for enabling such process.

On the basis of the communication method shown in FIG. 8, FIG. 9 is a schematic flowchart of a communication method according to another embodiment of the present disclosure, in which compression is enabled for the partial report. As shown in FIG. 9, the method includes as follows.

S901, the responder obtaining multiple partial reports of the measurement report based on the measurement report.

S902, the responder performing compression on a second partial report among the multiple partial reports.

S903, for a first partial report among the multiple partial reports, the responder performing fragmentation on the first partial report to obtain a first number of fragments.

S904, the responder obtaining the multiple measurement report frames.

In the above embodiment, the second partial report may be the same or different from the first partial report, and the execution order of steps 902 and 903 is not limited to herein. That is, among the multiple partial reports, some or all of the multiple partial reports may be taken as the first partial report(s) on which fragmentation will be done, and some or all of the multiple partial reports may be taken as the second partial report(s) on which compression will be done. The fragmentation and compression operations may be independent from each other. It should be noted although examples in the present disclosure are given by performing compression on all the partial reports, however, the solution is also applicable for cases where the compression is performed on one or some of the partial reports. Besides, in S904, if all the partial reports are compressed, then the responder obtains the multiple measurement report frames based on the compressed multiple partial reports; if some of the partial reports are compressed, then the responder obtains the multiple measurement report frames based on the compressed partial report(s) and the remaining partial report(s) which is(are) not compressed.

By performing compression on some or all of the partial reports, the overall signaling overhead is reduced.

In a possible implementation, a first measurement report frame corresponding to the first partial report is indicative of a first parameter specific to the first partial report, and the first measurement report frame carries the first fragment of the first partial report, and indications for the first parameter are omitted in remaining measurement report frames corresponding to the first partial report other than the first measurement report frame. The first partial report can be fragmented into several fragments, and each fragment may be carried in a measurement report frame. Since the first parameter specific to this partial report is common for all the fragments obtained, it is possible to simply carry the first parameter in the first measurement report frame corresponding to the first partial report, and omit indications for the first parameter in other measurement report frames corresponding to the first partial report, so as to reduce the signaling overhead. For example, the first partial report is fragmented into two segments, and each segment is carried in a measurement report frame, so there are two measurement report frames (MRF1 and MRF2) corresponding to the first partial report. Then the first parameter can be carried simply in the first measurement report frame (MRF1), then the second measurement report frame is the remaining measurement report frame corresponding to the first partial report, so in MRF2, no indication for the first parameter is carried.

In a possible implementation, the first measurement report frame includes a first parameter field for indicating the first parameter.

Here the first parameter may be parameters such as Timing offset between the reference tap and the CIR report timing grid, the normalization factor applied to the CIR Taps being reported in the CIR Taps field, the received signal strength at the antenna for the received sequence used to generate this receive report field. The first parameter may be carried in the individual report descriptor field (corresponding to the above first parameter field) which will be elaborated later with respect to specific frame formats.

In a possible implementation of the present disclosure, a second measurement report frame of the multiple measurement report frames is indicative of a second parameter for all partial reports of the measurement report, and the second measurement report frame is a first measurement report frame among the multiple measurement report frames, and indications for the second parameter are omitted in remaining measurement report frames other than the second measurement report frame. The measurement report may include multiple partial reports, and the second parameter may be parameters common to all partial reports of the measurement report, that is, the multiple measurement report frames used for carrying all the partial reports share the second parameter, so it is possible to simply carry the second parameter in the first measurement report frame among the multiple measurement report frames, and omit indications for the second parameter in other measurement report frames, so as to reduce the signaling overhead.

In a possible implementation of the present disclosure, the second measurement report frame includes a second parameter field for indicating the second parameter.

Here the second parameter may be parameters such as number of Rx antennas, number of segments, CIR bitmap, etc. The first parameter may be carried in the report parameter control field (corresponding to the above second parameter field) which will be elaborated later with respect to specific frame formats.

In a possible implementation of the present disclosure, the second measurement report frame further includes a parameter indication field for indicating whether the second parameter field is present.

In a possible implementation of the present disclosure, the respective measurement report frame is indicative of whether a fragment carried in the respective measurement report frame is a first fragment of a report from which the fragment is obtained, a number of remaining fragments in the report from which the fragment is obtained, and a length related to the fragment. As mentioned above, the result of measurement can be distributed in multiple measurement report frames, so for each of the multiple measurement report frames, it is necessary to indicate the fragment carried therein. Each measurement report frame may carry one or more fragments, if more than one fragment is carried, each fragment has to be indicated. Therefore, for each fragment carried in the measurement report frame, whether the fragment is a first fragment of a partial report from which the fragment is obtained, the number of remaining fragments in the partial report from which the fragment is obtained, and a length related to the fragment are indicated. It should be noted that it is possible that the length related to the fragment may be longer than the length of the fragment, since for carrying the fragment, other information such as the Individual Report Descriptor field may also be needed.

In a possible implementation of the present disclosure, the respective measurement report frame includes a first fragment field for indicating whether the fragment carried in the respective measurement report frame is a first fragment of the report from which the fragment is obtained, a remaining fragment field for indicating the number of remaining fragments in the report from which the fragment is obtained, and a fragmented report length field for indicating the length related to the fragment. Here the first fragment field may be implemented as the first report fragment field in the following examples, the remaining fragment field may be implanted as the remaining report fragments field in the following examples, and the fragmented report length field may be implemented as the partial report length field in the following examples.

In a possible implementation of the present disclosure, the respective measurement report frame further includes a fragment indication field for indicating whether the first fragment field, the remaining fragment field and the fragmented report length field are present. Here the fragment indication field may be implemented as the Fragment Indication field in the following examples.

In a possible implementation of the present disclosure, a respective measurement report frame of the multiple measurement report frames is indicative of an identification of the respective measurement report frame and the measurement. In a possible implementation of the present disclosure, the respective measurement report frame includes a report number for indicating the identification of the measurement report frame and a measurement number for identifying the measurement. In order to enable the initiator to correctly distinguish each measurement report frame, the respective measurement report frame is indicative of an identification of the respective measurement report frame and the measurement (the measurement instance). In this way, when there are different measurement instances implemented by the initiator and the responder, and when the result of one measurement instance (the measurement) is carried in different measurement report frames, the initiator could determine to which measurement instance each measurement report frame belongs, as well as distinguish measurement report frames belonging to the same measurement instance. Here the report number can be carried in the report SN field in the following examples, and the measurement number can be carried in the Measurement ID field in the following examples.

In a possible implementation of the present disclosure, the respective measurement report frame is further indicative of a segment to which a fragment of the measurement report carried by the respective measurement report frame belongs, an antenna of the responder for receiving the segment and a channel on which the segment is received. In a possible implementation of the present disclosure, the respective measurement report frame includes a segment field for identifying the segment to which the fragment of the measurement report carried by the respective measurement report frame belongs, an antenna field for identifying the antenna of the responder for receiving the segment and a channel field for identifying the channel on which the segment is received. Here the segment field may be implemented as the Segment ID or Segment ID bitmap field in the following examples, the antenna field may be implemented as the Rx Antenna ID or Rx Antenna ID bitmap field in the following examples, and the segment field may be implemented as the Channel ID or Channel ID bitmap field in the following examples.

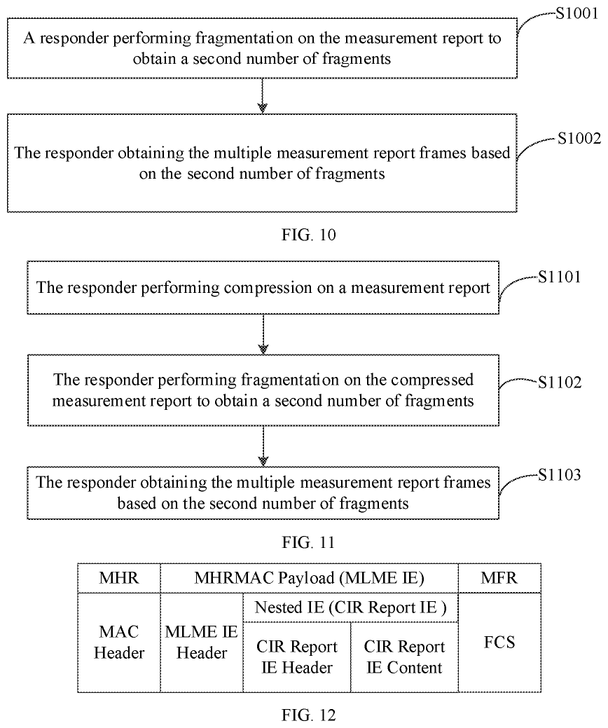

Another way is to perform the fragmentation directly on the measurement report without considering the boundary of the receive reports carried in the receive reports Field. FIG. 10 is a schematic flowchart of a communication method according to another embodiment of the present disclosure. As shown in FIG. 10, the method includes as follows.

S1001, a responder performing fragmentation on the measurement report to obtain a second number of fragments.

S1002, the responder obtaining the multiple measurement report frames based on the second number of fragments.

On the basis of the communication method shown in FIG. 10, FIG. 11 is a schematic flowchart of a communication method according to another embodiment of the present disclosure, in which compression is enabled for the measurement report. As shown in FIG. 11, the method includes as follows.

S1101, the responder performing compression on a measurement report.

S1102, the responder performing fragmentation on the compressed measurement report to obtain a second number of fragments.

S1103, the responder obtaining the multiple measurement report frames based on the second number of fragments.

Here the compression may serve to reduce the size of the measurement report, and would be beneficial for reducing the number of fragments and further reducing the number of measurement report frames carrying the fragments. Besides, it is also possible to compress some large field, for example, the CIR bitmap field when compressing the measurement report. By performing fragmentation on the measurement report directly, the operation is simplified, and more flexibility would be given to the design of formats of report IEs for enabling such process.

Besides, the specific value of the second number here may be determined based on actual needs, which is not limited in the embodiments of the present application.

In a possible implementation of the present disclosure, the measurement report is directly fragmented into includes a second number of fragments, each of the second number of fragments is carried in one measurement report frame, and the one measurement report frame includes a first fragment field for indicating whether the fragment carried in the respective measurement report frame is a first fragment of the report from which the fragment is obtained, a remaining fragment field for indicating the number of remaining fragments in the report from which the fragment is obtained, and a fragmented report length field for indicating the length related to the fragment. Here the first fragment field may be implemented as the first report fragment field in the following examples, the remaining fragment field may be implanted as the remaining report fragments field in the following examples, and the fragmented report length field may be implemented as the partial report length field in the following examples.

In a possible implementation of the first aspect, the CIR bitmap field in the report parameters control field can also be compressed with the measurement report.

In a possible implementation of the present disclosure, a second measurement report frame of the multiple measurement report frames is indicative of a second parameter for all partial reports of the measurement report, and the second measurement report frame is the first measurement report frame among the multiple measurement report frames, and indications for the second parameter are omitted in remaining measurement report frames other than the second measurement report frame. The measurement report may include multiple partial reports, and the second parameter may be parameters common to all partial reports of the measurement report, that is, the multiple measurement report frames used for carrying all the partial reports share the second parameter, so it is possible to simply carry the second parameter in the first measurement report frame among the multiple measurement report frames, and omit indications for the second parameter in other measurement report frames, so as to reduce the signaling overhead.

In a possible implementation of the present disclosure, the second measurement report frame includes a second parameter field for indicating the second parameter.

Here the second parameter may be parameters such as number of Rx antennas, number of segments, CIR bitmap, etc. The first parameter may be carried in the report parameter control field (corresponding to the above second parameter field) which will be elaborated later with respect to specific frame formats.

In a possible implementation of the present disclosure, the second measurement report frame further includes a parameter indication field for indicating whether the second parameter field is present.

In a possible implementation of the present disclosure, the respective measurement report frame is indicative of whether a fragment carried in the respective measurement report frame is a first fragment of a report from which the fragment is obtained, a number of remaining fragments in the report from which the fragment is obtained, and a length related to the fragment. As mentioned above, the result of measurement can be distributed in multiple measurement report frames, so for each of the multiple measurement report frames, it is necessary to indicate the fragment carried therein. Each measurement report frame may carry one or more fragments, if more than one fragment is carried, each fragment has to be indicated. Therefore, for each fragment carried in the measurement report frame, whether the fragment is a first fragment of the measurement report from which the fragment is obtained, the number of remaining fragments in the partial report from which the fragment is obtained, and a length related to the fragment are indicated. It should be noted that it is possible that the length related to the fragment may be longer than the length of the fragment, since for carrying the fragment, other information such as the individual report descriptor field may also be needed.

In a possible implementation of the present disclosure, the respective measurement report frame includes a first fragment field for indicating whether the fragment carried in the respective measurement report frame is a first fragment of the report from which the fragment is obtained, a remaining fragment field for indicating the number of remaining fragments in the report from which the fragment is obtained, and a fragmented report length field for indicating the length related to the fragment. Here the first fragment field may be implemented as the first report Fragment field in the following examples, the remaining fragment field may be implanted as the remaining report fragments field in the following examples, and the fragmented report length field may be implemented as the partial report length field in the following examples.

In a possible implementation of the present disclosure, the respective measurement report frame further includes a fragment indication field for indicating whether the first fragment field, the remaining fragment field and the fragmented report length field are present. Here the fragment indication field may be implemented as the Fragment Indication field in the following examples.

In a possible implementation of the present disclosure, a respective measurement report frame of the multiple measurement report frames is indicative of an identification of the respective measurement report frame and the measurement. In a possible implementation of the present disclosure, the respective measurement report frame includes a report number for indicating the identification of the measurement report frame and a measurement number for identifying the measurement. In order to enable the initiator to correctly distinguish each measurement report frame, the respective measurement report frame is indicative of an identification of the respective measurement report frame and the measurement (the measurement instance). In this way, when there are different measurement instances implemented by the initiator and the responder, and when the result of one measurement instance (the measurement) is carried in different measurement report frames, the initiator could determine to which measurement instance each measurement report frame belongs, as well as distinguish measurement report frames belonging to the same measurement instance. Here the report number can be carried in the report SN field in the following examples, and the measurement number can be carried in the Measurement ID field in the following examples.

In a possible implementation of the present disclosure, the respective measurement report frame is further indicative of a segment to which a fragment of the measurement report carried by the respective measurement report frame belongs, an antenna of the responder for receiving the segment and a channel on which the segment is received. In a possible implementation of the present disclosure, the respective measurement report frame includes a segment field for identifying the segment to which the fragment of the measurement report carried by the respective measurement report frame belongs, an antenna field for identifying the antenna of the responder for receiving the segment and a channel field for identifying the channel on which the segment is received. Here the segment field may be implemented as the Segment ID or Segment ID bitmap field in the following examples, the antenna field may be implemented as the Rx Antenna ID or Rx Antenna ID bitmap field in the following examples, and the segment field may be implemented as the Channel ID or Channel ID bitmap field in the following examples.

For the case where the fragmentation is done at the partial report level with consideration on the boundaries of the partial reports, since the CIR taps included in a partial report may be distributed into multiple fragments, and it is possible that a measurement report frame corresponds to more than one fragment, so each fragment included in the measurement report frame may be indicated with the first fragment field, the remaining fragment field and the fragmented report length field, so that the initiator could identify the fragment, and arrange multiple fragments of the same partial report in a correct order. For the case where the fragmentation is done directly on the measurement report without considering the boundaries, each measurement report frame may include the first fragment field, the remaining fragment field and the fragmented report length field to indicate the fragment carried therein.

As described in the above part, there may be two kinds of reports, formats (or structures) of these two reports will be elaborated in detail as follows. For the first kind of report, i.e., the windows-based CIR report, there may be two formats for the CIR report IE, and for the second kind of report, i.e., the processed target features report, an exemplary processed target feature IE is proposed.

In order to realize the above fragmentations, the format of the CIR eporrt IE should be designed so that the fragmentation can be notified to the initiator. In the following, the format of the CIR report IE will be described at first, and then the corresponding fragmentation and compression will be described with reference to the format of the CIR report IE.

The structure of the measurement report frame carrying a CIR report IE will be described in the first place. The measurement report frame is transmitted on a MAC sub-layer. As shown in FIG. 12, the MAC sub-layer consists of a MAC header, a MAC payload and a MAC Footer (MFR), and the MAC layer management entity information element (MLME IE) payload consists of an MLME IE header field, a nested IE (i.e., CIR report IE) field consisting of a CIR report IE header field and a CIR report IE content field, and the CIR report IE content field corresponds to the measurement report frame.

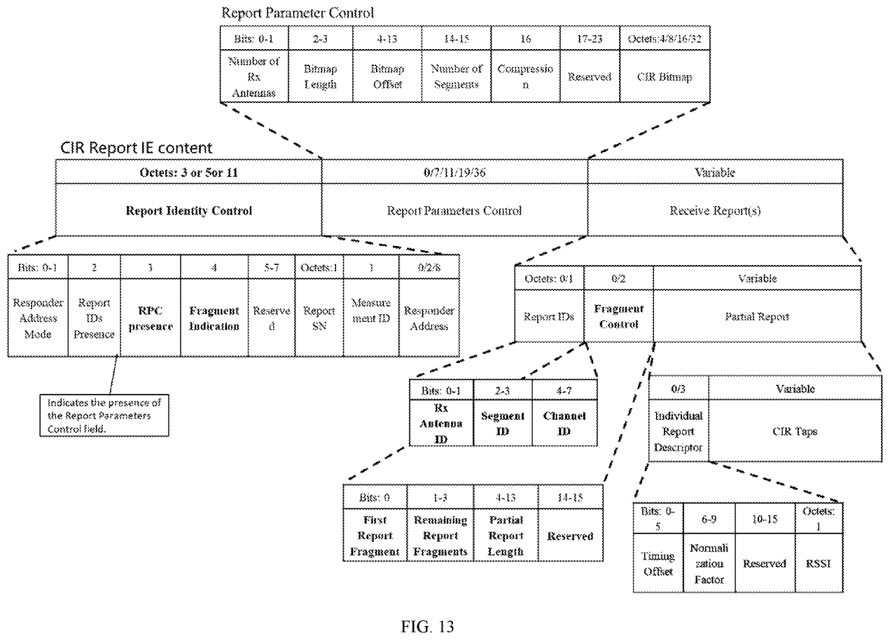

A specific example format of the CIR report IE content field corresponding to the measurement report frame will be described with reference to FIG. 13, the interesting fields are as follows.

(1) Report identity control: carries information that can be used to identify a measurement report frame and is present in all CIR report IEs. This section serves to provide parameters that would be used by the initiator to identify a certain measurement report frame, so the following fields may be included as follows.

Responder Address Mode: indicates the presence and size of the Responder Address field, for example:
b00: indicates that Responder Address field is not present.
b01: reserved
b10: indicates that Responder Address field contains a short address (16 bit).
b11: indicates that Responder Address field contains an extended address (64 bit)

Presence bits: indicate if the optional fields are present in the report.

Report SN: refers to a unique sequence number that identifies a specific measurement report frame. The report SN can be used for selective re-transmissions in case of transmission failure. The report SN is locally generated by the responder.

Measurement ID (MID): refers to a unique ID that identifies a particular measurement instance (the measurement performed by the responder as described above). The MID can be used by the initiator to identify reports corresponding to a particular measurement instance. The MID is locally generated by the responder.

Responder Address: identifies the SDEV (the responder) that generated the measurement report frame. It may be present in the SBP case and is optional for non-SBP. It may be either the 2 octets short address assigned to the responder or the 8 octets extended address of the responder. If the 2 octets short address is used in the CIR report transmitted by the responder, the initiator may replace it with the 8 octets extended address of the responder when forwarding the CIR report to the sensing requesting device.

Fragment Indication: indicates that the CIR report is fragmented and the Fragment Control field is present.

(2) Report parameter control: carries the parameters common to all partial reports with the same MID such as Number of Rx Antennas, Number of Segments, CIR Bitmap etc. When the partial reports corresponding to the same measurement instance is carried over multiple frames, this field may be only present in the very first measurement report frame corresponding to that measurement instance and is absent in the rest of the measurement report frames. This field may be the second parameter field mentioned above that is only present in the first measurement report frame among the multiple measurement report frames of the same measurement report, and is omitted in the remaining measurement report frames.

(3) Receive report(s): carries one or more partial reports and is present in all measurement report frame.

Report IDs: identifies a partial report and is present when the receive reports of the same measurement are carried in different CIR report or frames. If the report ID field is not present, it means that the entire report (all the partial reports) is carried in the IE. The report IDs may include the following fields:
Rx Antenna ID: ID of the receive antenna corresponding to the partial report carrying the CIR taps
Segment ID: ID of the segment of the sensing packet corresponding to the partial report carrying the CIR taps.
Channel ID: for a frequency stitched packet, it indicates the channel in which the CIR taps are measured. The Channel ID may be a relative index (instead of the actual physical channel index), e.g., CH 0 being the base channel, CH 1 being the next channel that is closest to the base channel etc. The field is reserved for a normal sensing packet. If more bits are available (e.g., 7 bits, the channel ID may also represent the actual logical ID of the channel used).

Fragment Control (present if the measurement report is fragmented):
First report fragment: indicates whether a fragment carried in the respective measurement report frame is a first fragment of a report from which the fragment is obtained, for example, it could be set to 1 for the 1st fragment of the partial report and set to 0 otherwise. The specific values of this field are not limited in the embodiments of the present disclosure.
Remaining report fragments: indicates the number of remaining fragments (the number of remaining fragments in the report from which the fragment is obtained). For example, it may be set to 0 for the last fragment. Set to a value between 1 and (2n−1) for a fragment that is not the last fragment. Here, n is the number of bits used for the remaining report fragments field. The specific values of this field are not limited in the embodiments of the present disclosure.
Partial report length: indicates the length (e.g., in octets) of the Partial Report field when the Partial Report field is fragmented. The number of bits required for the Partial Report Length field may be reduced, e.g., by representing as percentage of the total report length (e.g., 7 bits are enough to signal up to 100%).

Partial Report: carries the compressed CIR report when compression is enabled, else for each partial CIR report carries:
Individual Report Descriptor: carries report parameters specific to the partial report such as Timing offset between the reference tap and the CIR report timing grid, the normalization factor applied to the CIR Taps being reported in the CIR Taps field, the received signal strength at the antenna for the received sequence used to generate this Receive Report field. When a partial report is fragmented, this field is only present in the first fragment (with the First Report Fragment=1) and is absent in the rest of the fragments, since the report parameters are the same for all fragments of the same partial report. The field is always present in an unfragmented partial report. This field may be the first parameter field specific to the first measurement report frame among the multiple measurement report frames as mentioned above.
CIR Taps: contains the CIR tap values corresponding to the fragmented or unfragmented partial report, one value for each bit in the CIR Bitmap that is set to one, each CIR tap consists of a signed in-phase (I) value and a signed quadrature (Q) value. When the partial report is fragmented, the CIR taps are distributed across the fragments in the same order as indicated in the CIR Bitmap.

It should be noted that the specific values, and lengths, names of the above fields are just for illustration purpose, other values could be taken, as long as the function of each field is realized.

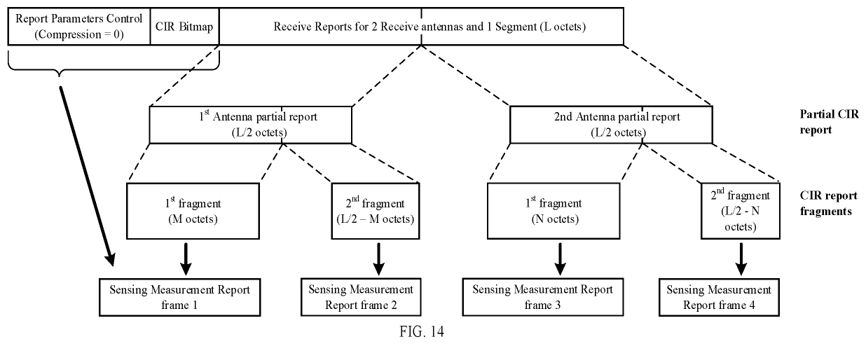

Now the fragmentation may be illustrated with reference to the above format. When the CIR reports (the measurement report mentioned above, which includes all the receive reports obtained for one measurement instance, the receive reports include CIR taps) corresponding to a single sensing measurement (also referred as a measurement instance) is too large to fit in a single frame, the receive reports may be divided into two or more partial reports, each partial report carrying all the CIR taps corresponding to a receive antenna and segment pair on a particular channel. Based on the capacity of the sensing measurement report frame (also referred as the measurement report frame), two or more measurement report frames are used to carry the measurement report, each frame carrying one or more partial reports. However, in some cases it may happen that even a single partial report is too big to fit in a single frame. In such cases, as shown in FIG. 14, each partial report may be further divided into two or more CIR report fragments (also referred as fragments), each fragment carrying a limited number of CIR taps corresponding to a receive antenna and segment pair, and each fragment carried in a separate measurement report frame. The Report Identity Control field is present in all four measurement report frames but the Report Parameter Control field is only present in the first measurement report frame. Similarly, the individual Report Descriptor field is only present in the first fragment of each partial report (with the First Report Fragment=1) and is absent in the rest of the fragments of the partial report, i.e., only present in the first and the third measurement report frames. The fragmentation without compression is a specific example of the process shown in FIG. 8.

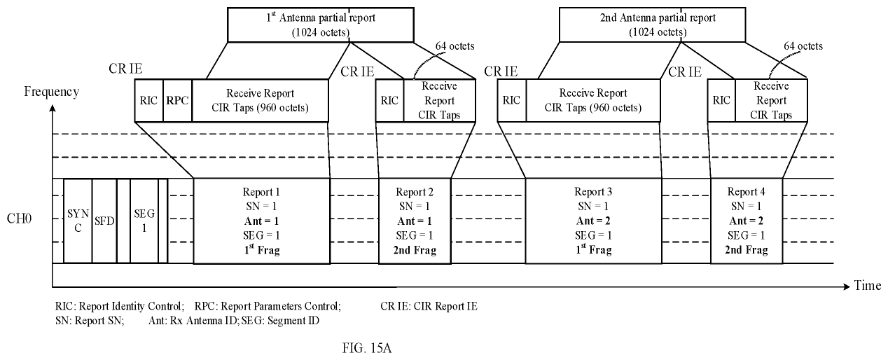

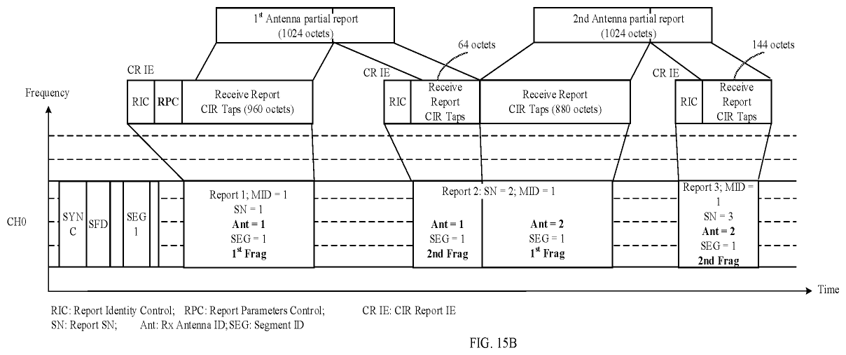

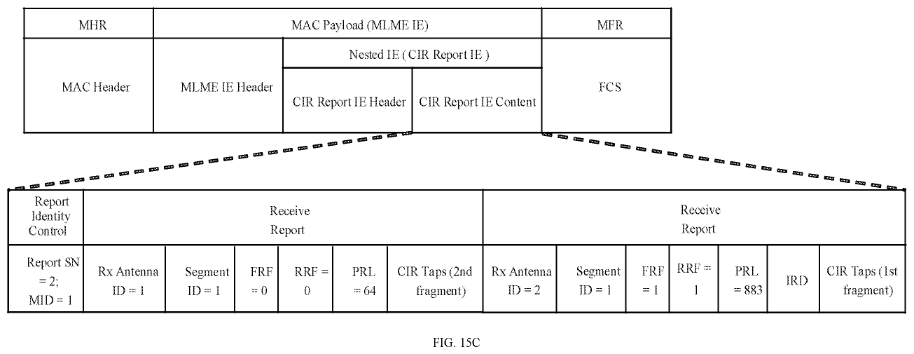

The following illustrates the fragmentation with reference to FIG. 15A to FIG. 15C as specific examples in combination with FIG. 14.

A specific example without compression is illustrated in FIG. 15A. The initiator transmits a sensing packet with a single sensing segment. The responder has 2 Receive antennas so in total 2 partial reports are required, one partial report for each receive antenna, sensing segment pair. In this example, the AC IE indicates a 32 octets CIR bitmap and a 16-bits for each of I and Q values, so each partial report is 1024 octets in size. Assuming that the preset threshold for one measurement report frame is 1000 octets, since the partial report can't fit in a single measurement report frame, each partial report needs to be divided into two fragments each and hence a total of 4 measurement report frames (and 4 CIR report IEs, or referred to as 4 CR IEs as illustrated in the figure) are required to feedback the CIR taps for the measurements. It is also to be noted that the Report Parameter Control (RPC) field is only present in the CIR report IE carrying the first fragment of the first partial report (in the first measurement report frame mentioned above) and is not present in the rest of the measurement report frames (the remaining measurement report frames mentioned above). The Individual Report Descriptor field is only present in the Receive Report filed of the CIR report IE (CR IE) carrying the first fragment corresponding to each partial report (both the first and third CR IEs in FIG. 15A), and is absent in the Receive Report filed of the CIR report IEs carrying the rest of fragments, the Individual Report Descriptor field is not shown in the figure. It should be noted that, throughout the text, in specific examples of the format of CIR report IE, interesting fields are shown, fields that are not shown may also exist in the CIR report IE. The Report parameter Control field may be only present in the first measurement report frame among the four measurement report frames corresponding to the same measurement instance, and may be omitted in the remaining measurement report frames.

It is also possible to combine the second and third measurement report frames in FIG. 15A into one measurement report frame, so as to reduce the overall signaling overhead. Since the second measurement report frame (and the corresponding CIR report IE) of FIG. 15A only carries 64 octets of CIR taps. Assuming that up to 960 CIR taps can be carried in each measurement report frame, with intelligent fragmentation of the second partial report (e.g., making the first fragment carry 880 octets of CIR taps), the second fragment of the first partial report and the first fragment of the second partial report may be carried in the same measurement report frame, resulting in three measurement report frames being enough to carry the entire CIR report. This is illustrated in FIG. 15B in detail. The Individual Report Descriptor field is present in the Receive Report field of the first CR IE since it carries the first fragment of the first partial report and in the second Receive Report filed of the second CR IE since it carries the first fragment of the second partial report, but is not present in the other Receive Report fields. The Report parameter Control field may be only present in the first measurement report frame among the three measurement report frames of the same measurement instance, and may be omitted in the remaining measurement report frames. FIG. 15C illustrates the structure of the second measurement report frame in the example in FIG. 15B more details. The fields are shown using abbreviations, in which FRF refers to First Report Fragment, RRF refers to Remaining Report Fragments, PRL refers to Partial Report Length, and IRD refers to Individual Report Descriptor mentioned above.

It should be note that, since the second measurement report frame as shown is the second measurement report frame for the same measurement instance, the Report Parameter Control field is not present. Two Receive Report fields are carried in the CIR report IE Content field, the first Receive Report field carrying the second fragment of the first partial report and the second Receive Report field carrying the first fragment of the second CIR report. The Individual Report Descriptor field is present in the second Receive Report field (with FRF=1) but not in the first Receive Report field. The Report Parameter Control field may be omitted in the second measurement report frame.

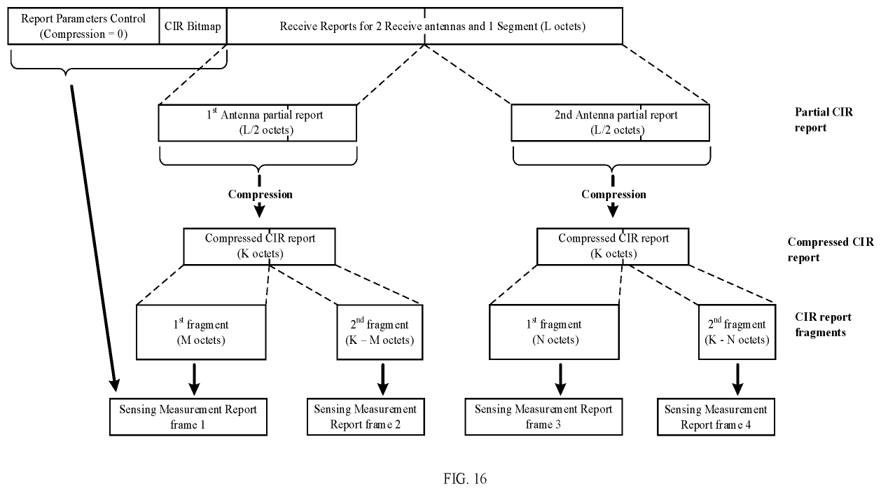

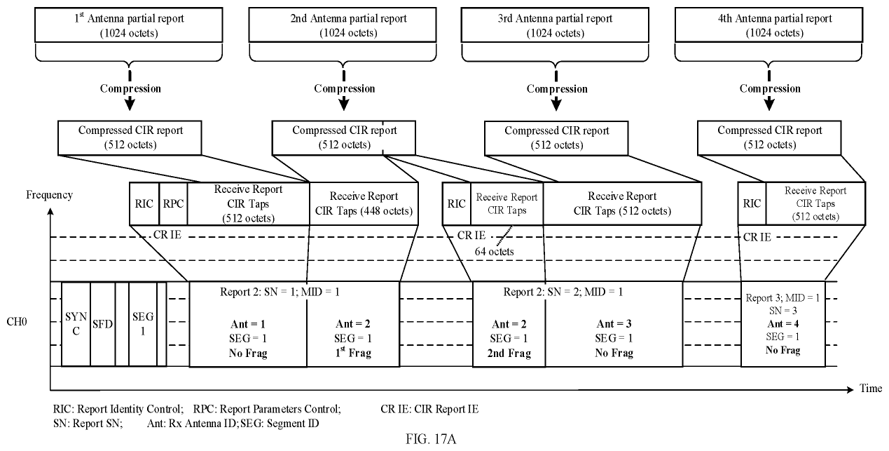

As mentioned above, compression may also be enabled during the fragmentation. A specific example with reference to the above format is shown in FIG. 16. The process is similar to the process in FIG. 14, except that each of the partial reports is first compressed (e.g., using DEFLATE). If the compressed CIR report (compressed partial report) is small enough, one or more measurement report frames are used to carry the compressed CIR reports, each frame carrying one or more compressed reports. However, if even a single compressed CIR report is too big to fit in a single frame, each compressed CIR report may be further divided into two or more fragments and each fragment carried in a separate frame. The fragmentation with compression is a specific example of the process shown in FIG. 9.

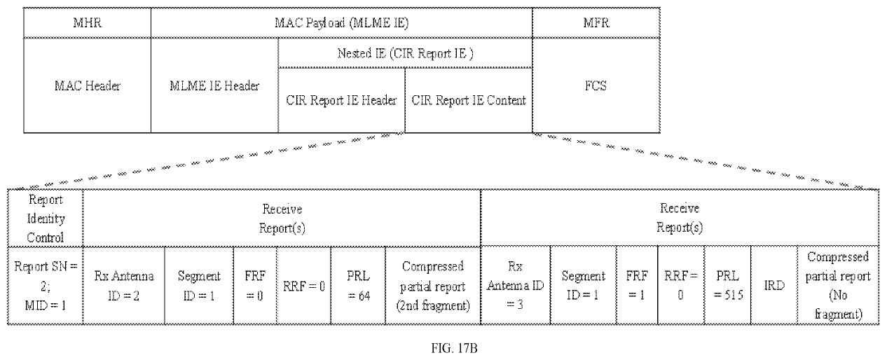

The following illustrates the fragmentation with reference to FIG. 17A to FIG. 17B as specific examples in combination with FIG. 16.

A specific example with compression is illustrated in FIG. 17A. The initiator transmits a sensing packet with a single sensing segment. The responder has 4 Receive antennas so in total 4 partial reports are required, one partial report for each receive antenna, sensing segment pair. In this example, the AC IE indicates a 32 octets CIR bitmap and a 16-bits for each of I and Q values, so each partial report is 1024 octets in size. The AC IE also indicates that compression is enabled. In this example, the compression efficiency is 50%, that is, after compression each of the partial report is 512 octets in size. While it is possible to use four measurements report frames to transport the four compressed partial reports (compressed CIR reports as shown in the figure), it is possible to use fragmentation on the second compressed partial report such that only three measurements report frames are sufficient to transport the entire CIR report. The first measurement report frame carries the first compressed partial report and the first fragment of the second compressed partial report; the second measurement report frame carries the second fragment of the second compressed partial report and the third compressed partial report, while the third measurement report frame carries the fourth compressed partial report. It is also to be noted that the Report Parameter Control field is only present in the CIR report IE carrying the first partial report (in the first measurement report frame) and is not present in the rest of the measurement report frames. The Individual Report Descriptor field may also be only present in the Receive Report filed of the CIR IE carrying the first fragment corresponding to each partial report, which is not shown in FIG. 17A. The Report parameter Control field may be only present in the first measurement report frame among the three measurement report frames of the same measurement instance, and may be omitted in the remaining measurement report frames.

FIG. 17B illustrates the structure of the second measurement report frame in the example in FIG. 17A with more details. Since the second measurement report frame as shown is the second measurement report frame for the same measurement instance, the Report Parameter Control field is not present. Two Receive Report fields are carried in the CIR report IE Content field, the first Receive Report field carrying the second fragment of the second compressed partial report and the second Receive Report field carrying the entire third compressed CIR report. The Individual Report Descriptor field is present in the second Receive Report field (with FRF=1) but not in the first Receive Report field. The Report parameter Control field may be omitted in the second measurement report frames.

While allowing flexible sizes of each fragment allows for more flexible adaptation to situation, it is also possible that for implementation simplicity, the size of the fragments except the last fragment (M and N in FIG. 14 and FIG. 16), is fixed to a certain size, e.g., 960 octets.

As mentioned above with reference to FIG. 10 and FIG. 11, the fragmentation can also be performed directly on the measurement report which includes all the receive reports corresponding to the same measurement instance. Different from the case where the fragmentation is done by at the partial report level with consideration of the boundaries of the partial reports, when the fragmentation is directly performed on the measurement report, the partial report may be separated apart.

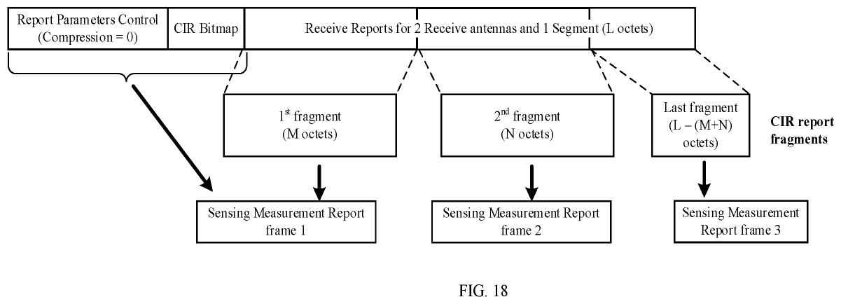

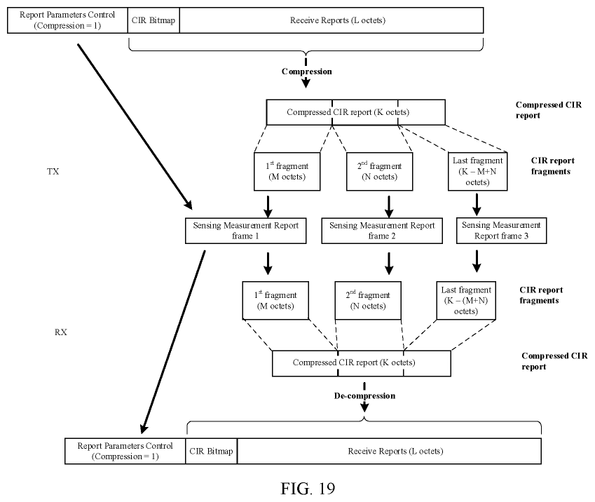

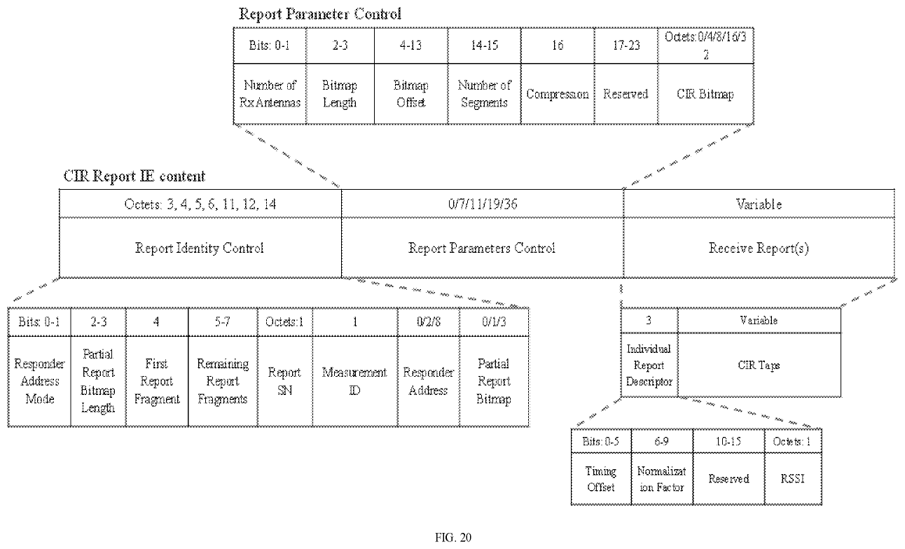

Specific examples with or without compression are shown FIG. 18 and FIG. 19. FIG. 18 shows the process in which compression is not enabled, when the CIR report (CIR taps) corresponding to a single sensing measurement is too large to fit in a single frame, the CIR report is divided into two or more CIR report fragments (without considering the partial CIR report boundaries), each fragment carrying a limited number of CIR taps, and each fragment carried in a separate frame. It is also possible that the CIR report is first divided into two or more partial CIR reports and fragmentation applied on the individual partial CIR report. FIG. 19 shows the process in which compression is enabled. As shown in FIG. 19, at the transmitter side (responder), the CIR report is first compressed (e.g., using DEFLATE) and if the compressed report (CIR taps) is too large to fit in a single frame, the compressed measurement report is fragmented in two or more fragments. In a possible implementation, other large fields, e.g., CIR Bitmap field may also be compressed together with the CIR taps. Each fragment is carried in one CIR report IE (measurement report frame). At the receiver side (initiator), the received fragments are first assembled in the right order. The assembled report is then decompressed to recover the original measurement report (and other fields that are compressed together, e.g., CIR Bitmap). The Report parameter Control field may be only present in the first measurement report frame among the three measurement report frames of the same measurement instance, and may be omitted in the remaining measurement report frames. Throughout the text, the terminology “sensing measurement report frame” and “measurement report frame” are used in an exchangeable way.

A specific example format of the CIR report IE content field corresponding to the measurement report frame mentioned in FIG. 18 and FIG. 19 will be described with reference to FIG. 20, the interesting fields are as follows:

(1) Report Identity Control: carries information that can be used to identify the measurement report is present in all CIR report IEs. This section serves to provide parameters that would be used by the initiator to identify a certain measurement report frame, so the following fields may be included as follows.

Responder Address Mode: indicates the presence and size of the Responder Address field, for example:
b00: indicates that Responder Address field is not present.
b01: reserved
b10: indicates that Responder Address field contains a short address (16 bit).
b11: indicates that Responder Address field contains an extended address (64 bit)

Partial Bitmap Length: identifies the length of the Partial Report Bitmap field, valid values, for example:
b00: 0 bits i.e., Partial Report Bitmap field is absent
b01: 8 bits (only the Rx Antenna ID Bitmap and Segment ID Bitmap are present)
b10: 24 bits (all 3 bitmaps are present)
b11: reserved.

First Report Fragment: Set to 1 for the 1st report fragment or for an unfragmented report and set to 0 otherwise.

Remaining Report Fragments: indicates the number of remaining report fragments. Set to 0 for the last report fragment or an unfragmented report. Set to a value between 1 and (2n−1) for a report fragment that is not the last fragment. Here, n is the number of bits used for the Remaining Report Fragments field.

Report SN: refers to a unique sequence number that identifies a specific measurement report frame. The Report SN can be used for selective re-transmissions in case of transmission failure. The Report SN is locally generated by the responder.

MID: refers to a unique ID that identifies a particular measurement instance (the measurement performed by the responder as described above). The MID can be used by the initiator to identify reports corresponding to a particular measurement instance. The MID is locally generated by the responder.

Responder Address: identifies the SDEV (the responder) that generated the measurement Report. It may be present in the SBP case and is optional for non-SBP. It may be either the 2 octets short address assigned to the responder or the 8 octets extended address of the responder. If the 2 octets short address is used in the CIR report IE transmitted by a responder, the initiator may replace it with the 8 octets extended address of the responder when forwarding the CIR Report to the sensing requesting device.

Partial Report Bitmap (present when the Receive Reports of the same measurement are carried in different measurement frames). If the bitmap is not present, the entire report is carried in the IE. The Partial Report Bitmap may includes the following fields:
Rx Antenna ID Bitmap: identifies that the ID of the receive antenna corresponding to the CIR taps is present.
Segment ID Bitmap: identifies that the ID of the segment of the sensing packet corresponding to the CIR taps is present.
Channel ID Bitmap: for a frequency stitched PPDU, it indicates the channel in which the CIR taps are measured. Reserved for a normal sensing packet.

(2) Report Parameter Control: carries the report parameters common to all reports with the same MID such as Number of Rx Antennas, Number of Segments, CIR Bitmap etc. When the measurement Report (or partial CIR reports) corresponding to the same measurement instance is carried over multiple frames, this field is only present in the very first measurement Report frame corresponding to that measurement instance (First Report Fragment field set to 1) and is absent in the rest of the measurement Report frame. When compression is enabled, some of the large fields, e.g., CIR Bitmap may also be compressed together with the receive reports. This field may be the second parameter field mentioned above that is only present in the first measurement report frame among the multiple measurement report frames of the same measurement report, and is omitted in the remaining measurement report frames.

(3) Receive Report(s): carries one or more partial reports corresponding to the receive antenna, segment and channel indicated in the partial report bitmap, or one of its fragment. When the partial report bitmap is present, the fragmentation is based on partial report.

Individual Report Descriptor: carries report parameters specific to the partial report such as Timing offset between the reference tap and the CIR report timing grid, the normalization factor applied to the CIR Taps being reported in the CIR Taps field, the received signal strength at the antenna for the received sequence used to generate this Receive Report field.

CIR Taps: contains the CIR tap values, one value for each bit in the CIR Bitmap that is set to one, each CIR tap consists of a signed in-phase (I) value and a signed quadrature (Q) value. When the report is fragmented, the CIR taps are distributed across the fragments in the same order as indicated in the CIR Bitmap.

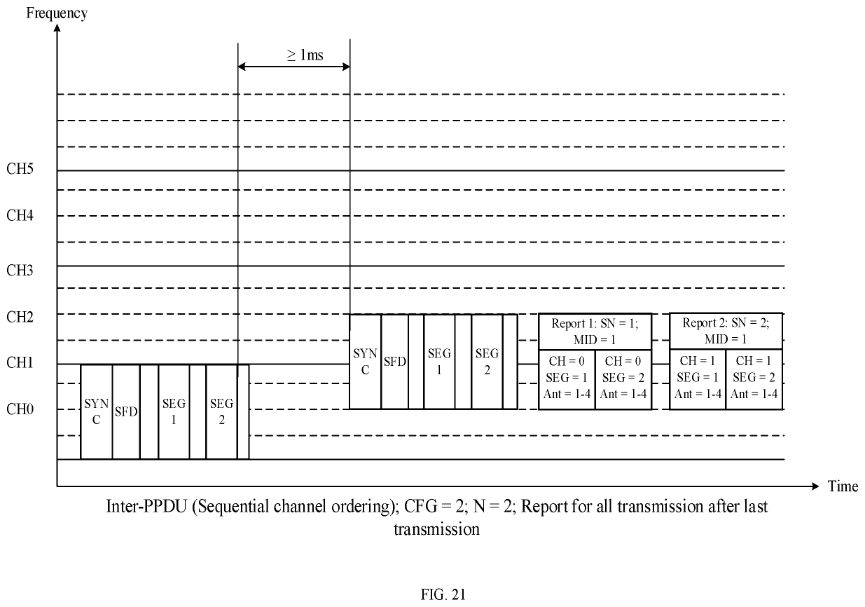

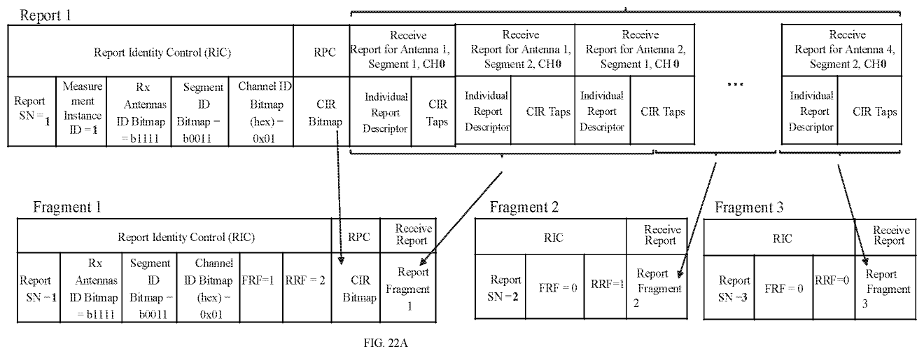

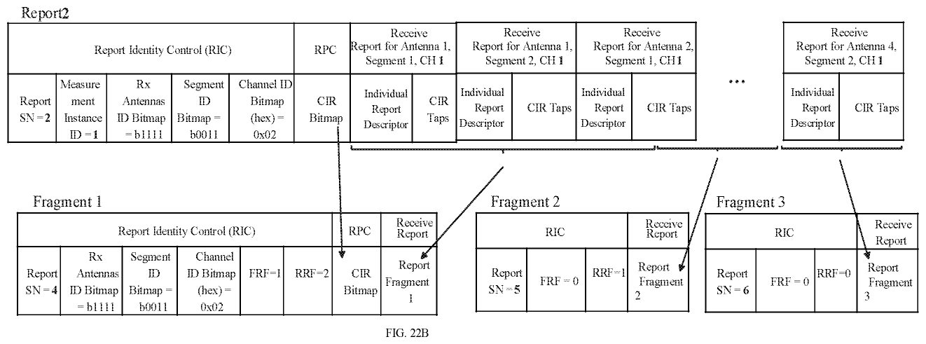

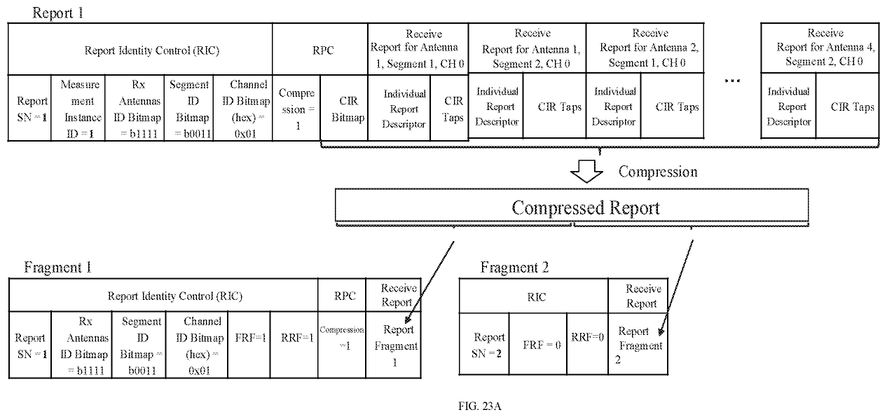

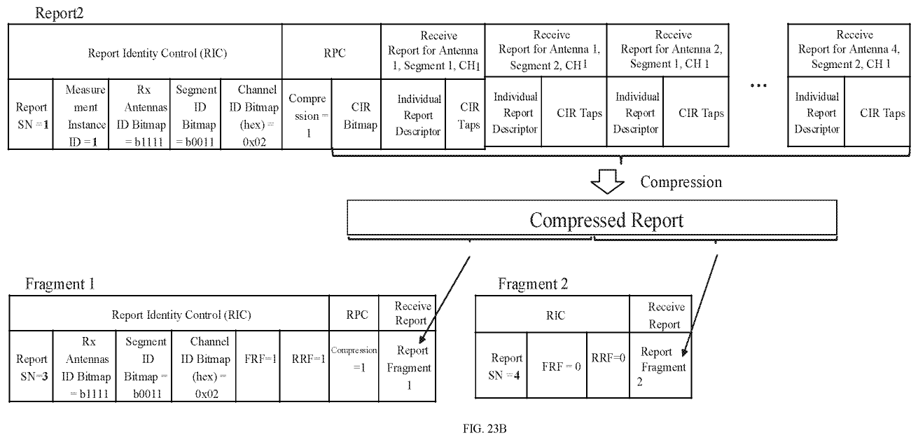

In the communication method according to a possible implementation of the present disclosure, the sensing packet transmitted by the initiator may include one or more sensing packets, each of the multiple sensing packets includes one or more segments; and the measurement report obtained based on the sensing packet may be one or more. The obtained measurement report may be fragmented according to the solutions of the present disclosure. The following illustrates the fragmentation of communication method using FIG. 21, FIG. 22A-FIG. 22B and FIG. 23A-FIG. 23B as specific examples with reference to the format shown in FIG. 20.

As shown in FIG. 21, which is an inter-packet frequency stitching type using out-of-sequence transmission, the initiator transmits two sensing packets on different channels CH0, CH1 to the responder, and each of the two sensing packets includes two segments SEG 1, SEG2. The responder transmits two measurement report frames according to the two sensing packet to the initiator. The carrier frequency grid parameter is set to 2 (50% overlap) and the number of transmissions (N)=2. The Channel Sequence Order field value in AC IE is 0 and the channels used are selected sequentially starting at the base channel (CH 0). The Frequency Stitching Type field in the AC IE is set as 1 (Inter-packet frequency stitching). Each sensing packet consists of two segments. The first sensing packet is transmitted (by the initiator) on the base channel (CH 0) while the second sensing packet is transmitted on the second channel (CH 1), e.g., at carrier frequency increment of 499.2 MHz from the base channel. Here, the two sensing packets are transmitted at least 1 ms apart in order to maximize the transmission power per transmission. This may also be signaled in the MMS Mode field in the AC IE. The responder measures the CIR taps for each segment (at each carrier frequency) using all four of its receive antennas. In this example the Report channel field of the Frequency Stitching Parameters field in the Sensing Control field of the AC IE is set as 1 (last channel). The Feedback Control field of the Frequency Stitching Parameters field in the Sensing Control field of the AC IE is set as 1 (Report for all transmission after the last transmission). Two CIR reports are generated, one for each channels.

The aforementioned AC IE (not shown) may include following fields.

Carrier frequency grid: used for indicating a carrier frequency grid configuration parameter (which is also referred to as carrier frequency grid parameter), such carrier frequency grid configuration parameter indicates whether the carrier frequencies of the channels overlap; for example, the carrier frequency grid parameter of 0, 1, 2, and 3 represent no overlap, 25% overlap, 50% overlap and 75% overlap respectively.

Number of transmissions: used for indicating the total number of transmissions to be done at the different channel center frequencies; in other words, the number of transmissions refers to the number of carrier frequencies used for the frequency stitching.

Channel Sequence Order: used for indicating whether the segments are transmitted in a sequential manner or an out-of-sequence manner, for example, when the Channel Sequence Order field is 0, it indicates the sequential manner, and when the Channel Sequence Order field is 1, it indicates the out-of-sequence manner. The sequential manner may refer to a manner in which adjacent segments of the same sensing packet are sequentially transmitted on channels whose carrier frequencies follow certain rules, or whose carrier frequencies distribute regularly, and the out-of-sequence manner may refer to a manner in which overlapped segments of the same sensing packet or overlapped sensing packets may be separated in the another dimension (different from the dimension where the overlapping occurs). For example, the overlapping may occur in the frequency domain, that is, channels which carry two adjacent segments may overlap, then these two segments may be separated in the time domain, for example, the time interval between the transmission of these two segments may be greater than 1 ms.

Frequency Stitching Type (not shown in the figure): used for indicating that the frequency stitching type with different values, for example, when its value is 0, the frequency stitching type is the intra-packet frequency stitching, when its value is 1, the frequency stitching type is the inter-packet frequency stitching, when its value is 2, the frequency stitching type is combination of intra-packet and inter-packet frequency stitching.

Report channel field: used for indicating the channel for transmitting the measurement report frame. For example, the base channel is used for transmitting the measurement report frame when its value is 0, and the last sensing packet is used for transmitting the measurement report frame when its value is 1. Here the base channel as mentioned above, refers to a starting channel for performing UWB sensing when frequency stitching is enabled, and the last channel refers to a channel on which the last segment of the last sensing packet is transmitted.

MMS Mode: used for indicating a gap between any two overlapping transmissions of the sensing packets or the segments of the same packet. For example, the gap may be less than 1 ms when the value of the MMS Mode field is 0 (corresponding to the sequential manner); and the gap between any two overlapping transmissions of the sensing packets or the segments of the same packet may be at least 1 ms when the value of the MMS Mode field is 1 (corresponding to the out-of-sequence manner). There could be two kinds of transmission, the sequential manner or the out-of-sequence manner, so this could also be indicated by the MMS mode.

Feedback Control: used for indicating different report formats. For example, when its value is 1, the report is for all transmissions after the last transmission, when its value is 2, the report is for aggregated channel after the last transmission.

CIR Bitmap: used for instructing the responder to measure the CIR taps for each of the bit set to 1 in the CIR Bitmap field.

FIG. 22A and FIG. 22B illustrate the possible contents of the measurement report frame in the example in FIG. 21 in the non-compression scenario using the format of the CIR report IE content field shown in FIG. 20. Since there are four partial reports corresponding to one segment (one for each receive antenna) and two segments, in total each report frame is expected to carry 8 partial reports (assuming no size limit). The MID field is set to the same value (e.g., 1) in both reports, while the Report SN are set as 1 and 2 respectively. The Rx Antenna ID Bitmap is set as b1111 to indicate that partial reports corresponding to all four receive antennas are present. The Segment ID Bitmap is set as b0011 to indicate that partial Reports corresponding to the first two segments are present. The lowest bit of the Channel ID Bitmap is set to 1 to indicate that the partial CIR reports corresponding to the first channel (CH 0) is present in the first report while the second lowest bit of the Channel ID Bitmap is set to 1 in the second report to indicate that the partial reports corresponding to the second channel (CH 1) is present in the second report. In each CIR report IE, multiple receive reports included in the Receive Report(s) field may be arranged in a fixed order, e.g., in the sequence of the antenna ID first and segment index second. In this example, even after partitioning into 2 partial Reports, the reports do not in a single report frame and hence the Receive Report(s) field of each report is split into 3 fragments, each fragment carrying a portion of the Receive Report(s) field and carried in a separate CIR report IE (and separate report frame). In total 6 CIR report IE are carried over 6 report frames.

FIG. 23A and FIG. 23B illustrate the possible contents of the measurement report frame in the example in FIG. 21 in the compression scenario using the format of the CIR report IE content field shown in FIG. 20. The process is similar to the process when compression is not enabled, but the Receive Report(s) field of each of the partial CIR report is first compressed. Some of the adjoining large fields (e.g., CIR Bitmap) may also be compressed together. If the compressed CIR reports are still too large to fit in a single report frame, the reports are further fragmented as describe above and transported over separate report frames.

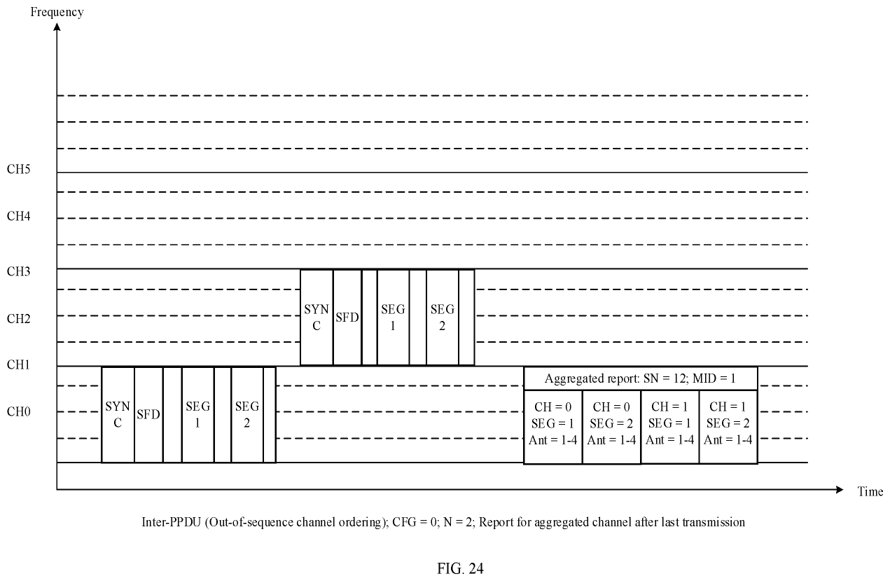

The example in FIG. 20 but assuming that the Feedback Control field of the Frequency Stitching Parameters field in the Sensing Control field of the AC IE is set as 2 (Report for aggregated channel after the last transmission), as shown in FIG. 24. Here, a single CIR Report for the aggregated channel (CH 0+CH 2) is generated by the responder.

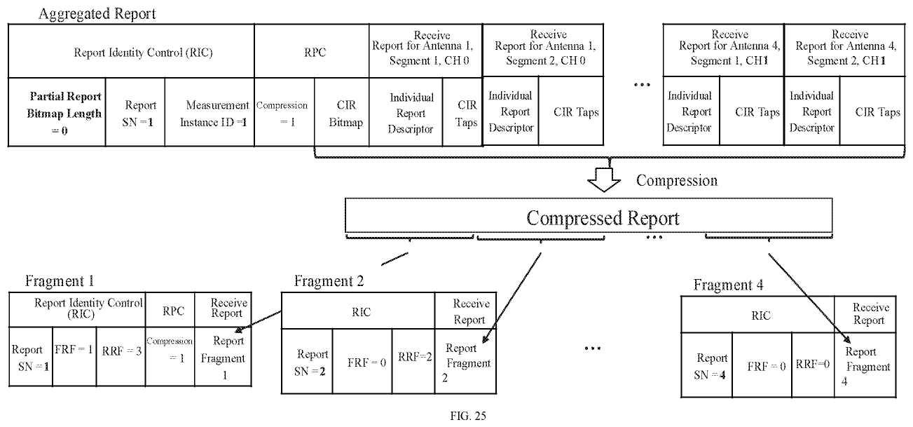

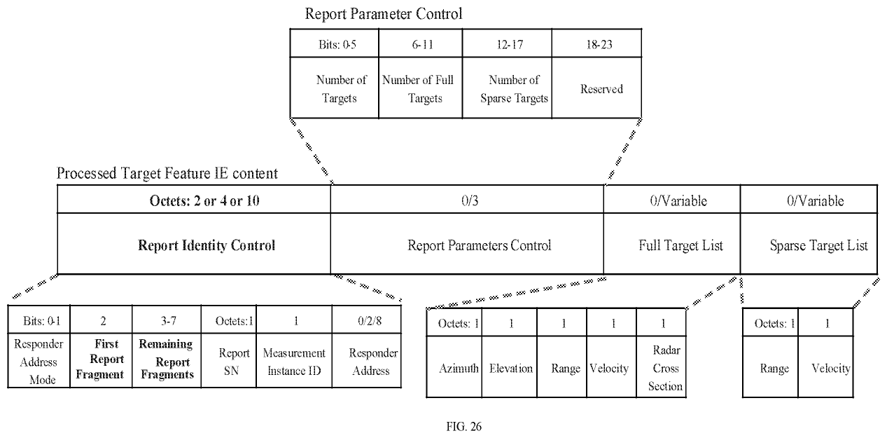

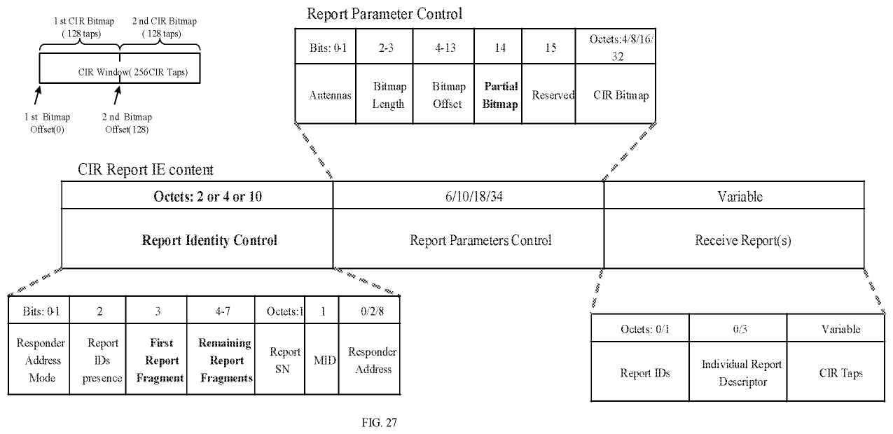

FIG. 25 illustrates the possible contents of the measurement report frame in the example in FIG. 24 using the format of the CIR report IE content field shown in FIG. 20. The process is similar to that described for FIG. 23A and FIG. 23B except that in this case the entire CIR report is compressed (and not the individual partial reports) and hence the partial Report Bitmap field is not present (equals to 0) in Report Identity Control field. Although not shown in any of FIG. 13, FIG. 20, FIG. 26, FIG. 27 or FIG. 25, when the measurement report is for the aggregated channel, a bit in the report (e.g., an Aggregated Channel bit in the Report Parameter Control field) in the Report IE in FIG. 13, FIG. 20, FIG. 26, FIG. 27 or FIG. 25 is set to 1 to alert the initiator that the measurement report is for the aggregated channel.

As can be seen from the above example, for the Report Identity Control field of the report before fragmentation and the Report Identity Control field of the report after fragmentation, the Report SN would be different since this number serves to distinguish the fragments from each other, but the Measurement ID would be the same since they correspond to the same measurement instance.

It should be noted that in all the examples shown above, the specific values (e.g., MID, Report SN) for fields are simply for illustration purpose, there is no limitation for these values.

In a possible implementation, instead of the reporting the raw CIR taps, it is also possible that a responder may first process the measured CIR taps and only report the processed target features such as angle of arrival (AoA), range, velocity, radar cross section (RCS) etc. A possible format of the Processed Target Feature IE used to report the processed target features that allows fragmentation is illustrated in FIG. 26. The interesting fields of the Processed Target Feature IE content fields are as follows.

(1) Report Identity Control: carries information that can be used to identify a measurement report.

Responder Address Mode: indicates the presence and size of the Responder Address field, for example:
b00: indicates that Responder Address field is not present.
b01: reserved
b10: indicates that Responder Address field contains a short address (16 bit).
b11: indicates that Responder Address field contains an extended address (64 bit)

First Report Fragment: set to 1 for the 1st report fragment or for an unfragmented report and set to 0 otherwise.

Remaining Report Fragments: indicates the number of remaining report fragments. Set to 0 for the last report fragment or an unfragmented report. Set to a value between 1 and (2n−1) for a report fragment that is not the last fragment. Here, n is the number of bits used for the Remaining Report Fragments field.

Report SN: refers to a unique sequence number that identifies a specific report frame. The Report SN can be used for selective re-transmissions in case of transmission failure. The Report SN is locally generated by the responder.

MID: refers to a unique ID that identifies a particular measurement instance. The MID can be used by the initiator to identify reports corresponding to a particular measurement instance (the measurement performed by the responder as described above). The MID is locally generated by the responder. When both CIR Report and process target features are reported for the same measurement instance, the same MID may be used in both the CIR report IE and the Processed Target Feature IE in order to aid the sensing initiator to map the two IEs.

Responder Address: identifies the SDEV (responder) that generated the processed target feature. It may be present in the SBP case and is optional for non-SBP. It may be either the 2 octets short address assigned to the sensing responder or the 8 octets extended address of the responder. If the 2 octets short address is used in the Processed Target Feature IE transmitted by a responder, the initiator may replace it with the 8 octets extended address of the responder when forwarding the Processed Target Feature IE to the sensing requesting device.

(2) Report Parameter Control: carries the report parameters common to all reports with the same MID such as Number of Targets, Number of Full Targets, Number of Sparse Targets etc.

(3) Full Target List: carries the complete processed features such as:
Azimuth: Azimuth of the target
Elevation: Elevation of the target
Range: Range of the target
Velocity: Velocity of the target
Radar Cross Section (RCS): Radar cross section of the target

(4) Sparse Target List: Carries the partial processed features such as:
Range: Range of the target
Velocity: Velocity of the target

If the Process Target Feature report IE is too large to fit in a single report frame, the Target Lists are fragmented as describe above and transported over separate report frames.

When performing the fragmentation on the partial reports, it is also possible to ensure the length of each measurement report frame from the perspective of the number of taps (e.g., CIR taps) carried in each measurement report frame. In this case, a different format of the measurement report frame may be adopted.

Further, the respective measurement report frame is indicative of the number of taps carried in the respective measurement report frame, and the indicated number of taps are less than a total number of taps to be reported. In a possible implementation, the respective measurement report frame includes a tap bitmap field for indicating the number of taps carried in the respective measurement report frame, and a bitmap indicated by the tap bitmap field is smaller than a bitmap required to indicate the total number of taps to be reported. Here the tap bitmap field may be implemented as the Partial Bitmap field in the report parameters control field in the following example.

In a possible implementation of the present disclosure, the respective measurement report frame is indicative of whether a fragment carried in the respective measurement report frame is a first fragment of a report from which the fragment is obtained, a number of remaining fragments in the report from which the fragment is obtained, and a length related to the fragment. As mentioned above, the result of measurement can be distributed in multiple measurement report frames, so for each of the multiple measurement report frames, it is necessary to indicate the fragment carried therein. Each measurement report frame may carry one or more fragments, if more than one fragment is carried, each fragment has to be indicated. Therefore, for each fragment carried in the measurement report frame, whether the fragment is a first fragment of a partial report from which the fragment is obtained, the number of remaining fragments in the partial report from which the fragment is obtained, and a length related to the fragment are indicated. It should be noted that it is possible that the length related to the fragment may be longer than the length of the fragment, since for carrying the fragment, other information such as the Individual Report Descriptor field may also be needed.

In a possible implementation of the present disclosure, the respective measurement report frame includes a first fragment field for indicating whether the fragment carried in the respective measurement report frame is a first fragment of the report from which the fragment is obtained, a remaining fragment field for indicating the number of remaining fragments in the report from which the fragment is obtained, and a fragmented report length field for indicating the length related to the fragment. Here the first fragment field may be implemented as the First Report Fragment field in the following examples, the remaining fragment field may be implanted as the Remaining Report Fragments field in the following examples, and the fragmented report length field may be implemented as the Partial Report Length field in the following examples.

In a possible implementation of the present disclosure, the respective measurement report frame further includes a fragment indication field for indicating whether the first fragment field, the remaining fragment field and the fragmented report length field are present. Here the fragment indication field may be implemented as the Fragment Indication field in the following examples.

In a possible implementation of the present disclosure, a respective measurement report frame of the multiple measurement report frames is indicative of an identification of the respective measurement report frame and the measurement. In a possible implementation of the present disclosure, the respective measurement report frame includes a report number for indicating the identification of the measurement report frame and a measurement number for identifying the measurement. In order to enable the initiator to correctly distinguish each measurement report frame, the respective measurement report frame is indicative of an identification of the respective measurement report frame and the measurement (the measurement instance). In this way, when there are different measurement instances implemented by the initiator and the responder, and when the result of one measurement instance (the measurement) is carried in different measurement report frames, the initiator could determine to which measurement instance each measurement report frame belongs, as well as distinguish measurement report frames belonging to the same measurement instance. Here the report number can be carried in the Report SN field in the following examples, and the measurement number can be carried in the Measurement ID field in the following examples.

In a possible implementation of the present disclosure, the respective measurement report frame is further indicative of a segment to which a fragment of the measurement report carried by the respective measurement report frame belongs, an antenna of the responder for receiving the segment and a channel on which the segment is received. In a possible implementation of the present disclosure, the respective measurement report frame includes a segment field for identifying the segment to which the fragment of the measurement report carried by the respective measurement report frame belongs, an antenna field for identifying the antenna of the responder for receiving the segment and a channel field for identifying the channel on which the segment is received. Here the segment field may be implemented as the Segment ID or Segment ID bitmap field in the following examples, the antenna field may be implemented as the Rx Antenna ID or Rx Antenna ID bitmap field in the following examples, and the segment field may be implemented as the Channel ID or Channel ID bitmap field in the following examples.

FIG. 27 illustrates the possible contents of the measurement report frame according to the above implementation. Here the CIR Bitmap field in the report parameters control field is used to fragment the measurement reports (or partial CIR reports). When the CIR report (CIR taps) corresponding to a single sensing measurement is too large to fit in a single frame, the CIR report is divided into two or more CIR report fragments, each fragment carrying a limited number of CIR taps, and each fragment carried in a separate frame. It is also possible that the measurement report is first divided into two or more partial reports and fragmentation applied on the individual partial report. When a measurement report (or a partial CIR report) is to be fragmented, instead of indicating the entire window of CIR taps in the CIR Bitmap field, only a section of the CIR tap window is carried in each fragment and the Bitmap Offset field and the CIR Bitmap field set accordingly.

The interesting fields of the CIR report IE content field corresponding to the measurement report frame are as follows:

(1) Report Identity Control: carries information that can be used to identify the measurement report is present in all CIR report IEs. This section serves to provide parameters that would be used by the initiator to identify a certain measurement report frame, so the following fields may be included as follows

Responder Address Mode: indicates the presence and size of the Responder Address field, for example:
b00: indicates that Responder Address field is not present.
b01: reserved
b10: indicates that Responder Address field contains a short address (16 bit).
b11: indicates that Responder Address field contains an extended address (64 bit)

Presence bits to indicate if the optional fields are present in the report.

First Report Fragment: set to 1 for the 1st report fragment or for an unfragmented report and set to 0 otherwise.

Remaining Report Fragments: indicates the number of remaining report fragments. Set to 0 for the last report fragment or an unfragmented report. Set to a value between 1 and (2n−1) for a report fragment that is not the last fragment. Here, n is the number of bits used for the Remaining Report Fragments field.

Report SN: refers to a unique sequence number that identifies a specific report frame. The Report SN can be used for selective re-transmissions in case of transmission failure. The Report SN is locally generated by the sensing responder.

MID: refers to a unique ID that identifies a particular measurement instance (the measurement performed by the responder as described above). The MID can be used by the initiator to identify reports corresponding to a particular measurement instance. The MID is locally generated by the responder.

Responder Address: identifies the SDEV (responder) that generated the CIR Report. It may be present in the SBP case and is optional for non-SBP. It may be either the 2 octets short address assigned to the responder or the 8 octets extended address of the responder. If the 2 octets short address is used in the CIR report IE transmitted by a sensing responder, the sensing initiator may replace it with the 8 octets extended address of the responder when forwarding the CIR report IE to the sensing requesting device.

(2) Report Parameter Control: carries the report parameters common to all reports with the same MID such as Number of Rx Antennas, Number of Segments, Partial Bitmap, CIR Bitmap etc. The CIR Bitmap size is chosen such that the corresponding CIR Taps can fit in the frame. In such cases, the Partial Bitmap field is set to 1 to indicate that the CIR Bitmap is partially set.

(3) Receive Report(s): carries one or more partial reports corresponding to the receive antenna, segment and channel indicated in the partial report bitmap, or one of its fragment. When the partial report bitmap is present, the fragmentation is based on partial report.

Individual Report Descriptor: carries report parameters specific to the partial report such as Timing offset between the reference tap and the CIR report timing grid, the normalization factor applied to the CIR Taps being reported in the CIR Taps field, the received signal strength at the antenna for the received sequence used to generate this Receive Report field.

CIR Taps: contains the CIR tap values, one value for each bit in the CIR Bitmap that is set to one, each CIR tap consists of a signed in-phase (I) value and a signed quadrature (Q) value.

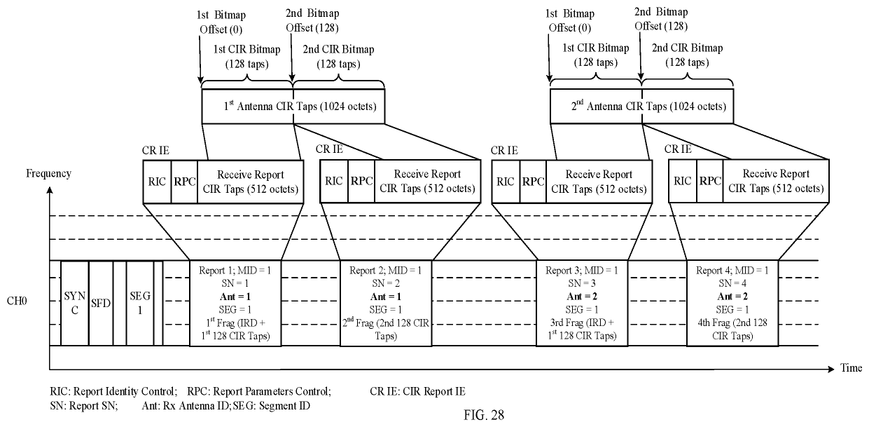

The following illustrates the fragmentation of communication method using FIG. 28 as specific examples in combination with FIG. 27. As shown in FIG. 28, the initiator transmits a sensing packet with a single segment. The responder has 2 Receive antennas so in total 2 partial reports are required, one partial report for each receive antenna, SENS segment pair. In this example, the AC IE indicates a 32 octets CIR bitmap and a 16-bits for each of I and Q values, so each partial report is 1024 octets in size. Since the partial report can't fit in a single frame, each partial report needs to be divided into two fragments each and hence a total of 4 sensing report frames (and 4 CIR report IEs) are required to feedback the CIR taps for the sensing measurements. In the first fragment of the first partial report, the Bitmap Offset field is set as 0 to point to the start of the CIR taps window, while the CIR Bitmap of size 16 octets is signaled (instead of 32 octets) and only the CIR taps in the first half of the CIR taps windows are indicated and also carried in the Receive Report field. Subsequently in the second fragment of the first partial report, the Bitmap Offset field is set as 128 to point to the center of the CIR taps window, while the CIR Bitmap of size 16 octets is signaled (instead of 32 octets) and only the CIR taps in the second half of the CIR taps windows are indicated and also carried in the Receive Report field. In order to alert the initiator that the CIR Bitmap field is only partially set, the Partial Bitmap field in the report parameters control is set to 1. The First Report Fragment and the Remaining Report Fragments are also set as described previously to track the different fragments of the same CIR report. The second partial report is also fragmented similarly. In this method, since the CIR Bitmap field is required in all fragments, the Report Parameter Control field is present in all the CIR report IEs.

It should be noted that in all the examples shown above, the specific values (e.g., MID, Report SN) for fields are simply for illustration purpose, there is no limitation for these values.

As can be seen from the above description, the number of CIR taps carried in each of the CIR IEs is smaller than the entire number of CIR taps, thus realizing the fragmentation of the partial report.

According to the embodiments of the present disclosure, the CIR report (CIR taps) corresponding to a single sensing measurement may be divided into two or more partial CIR reports, each partial CIR report carrying all the CIR taps corresponding to a receive antenna and segment pair on a particular channel. A partial CIR report allows the CIR report to be divided into smaller components, each component carrying a complete set of CIR taps for a receive antenna and segment pair. Besides, the partial CIR report may be further divided into two or more CIR report fragments, each fragment carrying a limited number of CIR taps corresponding to a receive antenna and segment pair. When fragmentation is based on partial CIR reports, even if some fragments are lost, the remaining received fragments can still be used to recover some of the partial CIR reports, allowing partial sensing measurements to be obtained. Further, the partial CIR report may be compressed prior to fragmentation, each fragment carrying a portion of the compressed CIR report, thus reducing the overall signaling overhead.

Next, embodiments of products related to the wireless communication methods will be described.

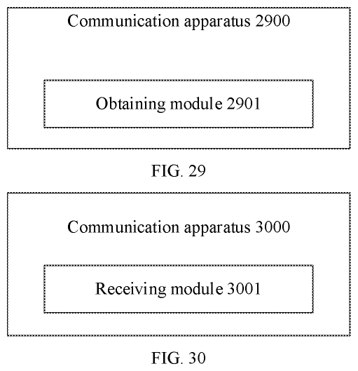

FIG. 29 shows a schematic structural diagram of a wireless communication apparatus according to one or more embodiments of the present disclosure. As shown in FIG. 29, the communication apparatus 2900 may include: an obtaining module 2901, configured to obtain multiple measurement report frames based on a measurement report, where the measurement report is used to provide a result of measurement performed by the responder, the result of the measurement is distributedly carried in the multiple measurement report frames, and a respective measurement report frame of the multiple measurement report frames has a length not greater than a preset threshold.

It should be noted that the obtaining module could also be referred to as a generating module, and the obtaining step performed by the responder in the above method embodiments could also be a generating step.

In a possible implementation of the first aspect, the obtaining module 2901 is further configured to receive at least one sensing packet from an initiator; and measure the at least one sensing packet to obtain the measurement report.

In a possible implementation, the obtaining module 2901 is further configured to obtain multiple partial reports of the measurement report based on the measurement report; for a first partial report among the multiple partial reports, perform fragmentation on the first partial report to obtain a first number of fragments; and obtain the multiple measurement report frames based on the first number of fragments for the first partial report.

In a possible implementation, the obtaining module 2901 is further configured to perform compression on a second partial report among the multiple partial reports.

In a possible implementation, where a first measurement report frame corresponding to the first partial report is indicative of a first parameter specific to the first partial report, and the first measurement report frame carries a first fragment of the first partial report, and indications for the first parameter are omitted in remaining measurement report frames corresponding to the first partial report other than the first measurement report frame.

In a possible implementation, where the first measurement report frame includes a first parameter field for indicating the first parameter.

In a possible implementation, the obtaining module 2901 is further configured to perform fragmentation on the measurement report to obtain a second number of fragments; and obtain the multiple measurement report frames based on the second number of fragments.

In a possible implementation, the obtaining module 2901 is further configured to perform compression on the measurement report; perform fragmentation on the compressed measurement report.

In a possible implementation, where a second measurement report frame of the multiple measurement report frames is indicative of a second parameter for all partial reports of the measurement report, and the second measurement report frame is a first measurement report frame among the multiple measurement report frames, and indications for the second parameter are omitted in remaining measurement report frames other than the second measurement report frame.

In a possible implementation, where the second measurement report frame includes a second parameter field for indicating the second parameter.

In a possible implementation, where the second measurement report frame further includes a parameter indication field for indicating whether the second parameter field is present.

In a possible implementation, where the respective measurement report frame is indicative of a number of taps carried in the respective measurement report frame, and the indicated number of taps are less than a total number of taps to be reported.

In a possible implementation, where the respective measurement report frame includes a tap bitmap field for indicating the number of taps carried in the respective measurement report frame, and a bitmap indicated by the tap bitmap field is smaller than a bitmap required to indicate the total number of taps to be reported.

In a possible implementation, where the respective measurement report frame is indicative of whether a fragment carried in the respective measurement report frame is a first fragment of a report from which the fragment is obtained, a number of remaining fragments in the report from which the fragment is obtained, and a length related to the fragment.

In a possible implementation, where the respective measurement report frame includes a first fragment field for indicating whether the fragment carried in the respective measurement report frame is a first fragment of the report from which the fragment is obtained, a remaining fragment field for indicating the number of remaining fragments in the report from which the fragment is obtained, and a fragmented report length field for indicating the length related to the fragment.

In a possible implementation, where the respective measurement report frame further includes a fragment indication field for indicating whether the first fragment field, the remaining fragment field and the fragmented report length field are present.

In a possible implementation, where a respective measurement report frame of the multiple measurement report frames is indicative of an identification of the respective measurement report frame and the measurement.

In a possible implementation, where the respective measurement report frame includes a report number for indicating the identification of the measurement report frame and a measurement number for identifying the measurement.

In a possible implementation, where the respective measurement report frame is further indicative of a segment to which a fragment of the measurement report carried by the respective measurement report frame belongs, an antenna of the responder for receiving the segment and a channel on which the segment is received.

In a possible implementation, where the respective measurement report frame includes a segment field for identifying the segment to which the fragment of the measurement report carried by the respective measurement report frame belongs, an antenna field for identifying the antenna of the responder for receiving the segment and a channel field for identifying the channel on which the segment is received.

In a possible implementation, the apparatus further includes a transmitting module configured to transmit the multiple measurement report frames to an initiator.

The communication apparatus may be applied to the responder as described in the above method embodiments or may be the responder as described in the above method embodiments. It should be understood by a person skilled in the art that, the relevant description of the above modules in the embodiments of the present disclosure may be understood with reference to the relevant description of the communication method in the embodiments of the present disclosure.

FIG. 30 shows a schematic structural diagram of a wireless communication apparatus according to one or more embodiments of the present disclosure. As shown in FIG. 30, the communication apparatus 3000 may include a receiving module 3001 configured to receive multiple measurement report frames from a responder, where the multiple measurement report frames are obtained based on a measurement report, where the measurement report is used to provide a result of measurement performed by the responder, the result of the measurement is distributedly carried in the multiple measurement report frames, and a respective measurement report frame of the multiple measurement report frames has a length not greater than a preset threshold.

The communication apparatus may be applied to the initiator as described in the above method embodiments or may be the initiator as described in the above method embodiments. It should be understood by a person skilled in the art that, the relevant description of the above modules in the embodiments of the present disclosure may be understood with reference to the relevant description of the communication method in the embodiments of the present disclosure.

An embodiment of the present disclosure provides a responder including processing circuitry for executing any of the above communication methods. It should be understood that the responder can execute the steps performed by the responder in the above method embodiments, which will not be repeated here.

An embodiment of the present disclosure provides an initiator including processing circuitry for executing any of the above communication methods. It should be understood that the initiator can execute the steps performed by the initiator in the above method embodiments, which will not be repeated here.

An embodiment of the present disclosure provides a communication apparatus which includes a processor and a memory. The memory is storing instructions that cause the processor to perform any of the above communication methods.

An embodiment of the present disclosure provides a communication system, including a responder and an initiator. The responder is configured to execute the steps executed by the responder in any of the above communication methods, and the initiator is configured to execute the steps executed by the initiator in any of the above communication methods.

An embodiment of the present disclosure provides a computer-readable medium storing computer execution instructions which, when executed by a processor, causes the processor to execute any of the above communication methods.

An embodiment of the present disclosure provides a computer program product including computer execution instructions which, when executed by a processor, causes the processor to execute any of the above communication methods.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including digital versatile discs (DVDs), compact disc (CD)-ROMs, Universal Serial Bus (USB) flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although embodiments have been described above with reference to the accompanying drawings, those of skill in the art will appreciate that variations and modifications may be made without departing from the scope thereof as defined by the appended claims.

1. A method implemented by a responder, wherein the method comprises:
obtaining, based on a measurement report, measurement report frames, wherein the measurement report comprises a result of measurement, wherein the result of the measurement is carried in the measurement report frames, and wherein a respective measurement report frame of the measurement report frames has a length not greater than a payload limit; and
transmitting the measurement report frames to an initiator.

2. The method of claim 1, wherein obtaining the measurement report frames comprises performing fragmentation on at least a portion of the measurement report to obtain fragments carried in the measurement report frames.

3. The method of claim 1, further comprising performing compression on CIR Taps fields of receive reports in the measurement report.

4. The method of claim 1, wherein the respective measurement report frame comprises a fragment and a first fragment field indicating whether the fragment in the respective measurement report frame is a first fragment of the measurement report.

5. The method of claim 1, wherein the respective measurement report frame comprises a remaining fragment field indicating a number of remaining fragments in the measurement report.

6. The method of claim 1, wherein the respective measurement report frame comprises a measurement number identifying the measurement.

7. The method of claim 1, wherein the respective measurement report frame comprises a segment field identifying a segment to which a fragment of the measurement report carried by the respective measurement report frame belongs, an antenna field identifying an antenna of the responder for receiving the segment, and a channel field identifying a channel on which the responder receives the segment.

8. The method of claim 1, wherein the respective measurement report frame comprises a channel impulse response (CIR) Bitmap and a CIR Taps field, wherein the CIR Taps field comprises CIR tap values, and wherein each of the CIR tap values corresponds to a respective bit in the CIR Bitmap that is set to one.

9. An apparatus, comprising:
at least one memory configured to store instructions; and
at least one processor coupled to the at least one memory and configured to execute the instructions to cause the apparatus to:
obtain, based on a measurement report, measurement report frames, wherein the measurement report comprises a result of measurement, wherein the result of the measurement is carried in the measurement report frames, wherein a respective measurement report frame of the measurement report frames has a length not greater than a payload limit; and
transmit the measurement report frames to an initiator.

10. The apparatus of claim 9, wherein the at least one processor is further configured to execute the instructions to cause the apparatus to further obtain the measurement report frames by performing fragmentation at least a portion of on the measurement report to obtain fragments carried in the measurement report frames.

11. The apparatus of claim 9, wherein the at least one processor is further configured to execute the instructions to cause the apparatus to perform compression on CIR Taps fields of receive reports in the measurement report.

12. The apparatus of claim 9, wherein the respective measurement report frame comprises a fragment and a first fragment field indicating whether the fragment in the respective measurement report frame is a first fragment of the measurement report.

13. The apparatus of claim 9, wherein the respective measurement report frame comprises a remaining fragment field indicating a number of remaining fragments in the measurement report.

14. The apparatus of claim 9, wherein the respective measurement report frame comprises a measurement number identifying the measurement.

15. The apparatus of claim 9, wherein the respective measurement report frame comprises a segment field identifying a segment to which a fragment of the measurement report carried by the respective measurement report frame belongs, an antenna field identifying an antenna of the apparatus for receiving the segment, and a channel field identifying a channel on which the apparatus receives the segment.

16. The apparatus of claim 9, wherein the respective measurement report frame comprises a channel impulse response (CIR) Bitmap and a CIR Taps field, wherein the CIR Taps field comprises CIR tap values, and wherein each of the CIR tap values corresponds to a respective bit in the CIR Bitmap that is set to one.

17. A computer program product comprising computer-executable instructions that are stored on a non-transitory computer-readable storage medium and that, when executed by at least one processor, cause an apparatus to:
obtain, based on a measurement report, measurement report frames, wherein the measurement report comprises a result of measurement, wherein the result of the measurement is carried in the measurement report frames, wherein a respective measurement report frame of the measurement report frames has a length not greater than a payload limit; and
transmit the measurement report frames to an initiator.

18. The computer program product of claim 17, wherein the respective measurement report frame comprises a fragment and a first fragment field indicating whether the fragment in the respective measurement report frame is a first fragment of the measurement report.

19. The computer program product of claim 17, wherein the respective measurement report frame comprises a remaining fragment field indicating a number of remaining fragments in the measurement report.

20. The computer program product of claim 17, wherein the respective measurement report frame comprises a measurement number identifying the measurement.
